(19) United States
(12) Patent Application Publication
(10) Pub. No.: US 2002/0154361 A1
(43) Pub. Date: Oct. 24, 2002

(54) Wavelength division multiplexed (WDM) network element and a method for propagating data packets across the network element

(76) Inventors: Benny Pesach, Rosh-Ha'ain (IL); Yigal Rappaport, Holon (IL); Ron Nagar, Tel Aviv (IL); Shlomo Reches, Petah Tiqvu (IL)

Correspondence Address: MERCHANT & GOULD PC, P.O. BOX 2903, MINNEAPOLIS, MN, 55402-0903, US

(21) Appl. No.: 09/839,461

(22) Filed: Apr. 20, 2001

(51) Int. Cl. H04J 14/02; H04J 14/08

(52) U.S. Cl. 359/139; 359/124

(57) ABSTRACT

A network element and a method for propagating data packet from an input port of a network element to an output port of the network element, the network element comprising a plurality of input ports and a plurality of output ports interconnected by an optical switch, the method including the steps of: receiving the data packet at an input port; processing the data packet to determine a destination output port out of the output ports of the network element; partitioning the data packet to a plurality of fixed sized cells; for each fixed sized cell of the data packet: optically transmitting in parallel optical signals to an optical switch, the optical signals being representative of all the bits of a fixed sized cell, switching the optical signals across the optical switch in view of the destination output port, during a single switching cycle, and converting the optical signals to electrical signals being representative of the fixed size cells; accumulating electrical signals being representative of fixed sized cells of the same data packet to provide a data packet; and providing the data packet to the destination output port.

### FIELD OF THE INVENTION

The present invention relates to network routing and especially to a network element and a method for propagating data packet across the network element.

### BACKGROUND OF THE INVENTION

Wavelength division multiplexed (WDM) network elements usually have a plurality of input ports and a plurality of output ports coupled to each other by at least one optical crossbar, optical switching plane or optical switching means. Due to various reasons, such as but not limited to time constraints, non-optimal crossbar resource allocation schemes and growing number of I/O ports and amount of received and transmitted data packets, only a portion of the network element resources are utilized. At WDM network elements configured to switch multiple data packets using various wavelengths this partial utilization is reflected by a partial utilization of wavelengths. Prior art components are not configured to switch large amount of optical signals in ultra fast speed.

There is a need to provide a network element that offers an improved utilization of wavelengths and network element resources and to provide a method for efficiently propagating data packets across a network element.

### SUMMARY OF THE INVENTION

The invention provides a method for propagating a data packet from an input port of a network element to an output port of the network element, the network element including a plurality of input ports and a plurality of output ports interconnected by an optical switch, the method including the steps of: (a) receiving the data packet at an input port; (b) processing the data packet to determine a destination output port out of the output ports of the network element; (c) partitioning the data packet to a plurality of fixed sized cells; for each fixed sized cell that belongs to the data packet repeating steps (d)-(e) of: (d) optically transmitting in parallel optical signals to an optical switch, the optical signals being representative of all the bits of the fixed sized cell; (e) switching the optical signals across the optical switch to at least one path leading to the destination output port; (f) reconstructing the data packet from the received optical signals; and (g) providing the data packet to the destination output port. The parallel transmission of all bits of the fixed sized cell, each on a separate wavelength, fully utilizes the wavelength resources of the network element, and allows to handle large amount of data packet traffic with a relatively simple optical switch. The optical switch is ultra fast and has relatively few ports. The method simplifies contention resolution and allows to use fixed lasers for performing electrical to optical conversion, instead of tunable lasers that are relatively slow and costly.

### BRIEF DESCRIPTION OF THE DRAWINGS

While the invention is pointed out with particularity in the appended claims, other features of the invention are disclosed by the following detailed description taken in conjunction with:

FIG. 1 is a schematic diagram illustrating a portion of a network that is interconnected to a plurality of networks, according to a preferred embodiment of the invention;

FIGS. 2a-5a are schematic diagrams illustrating portions of a network element of the network, according to a preferred embodiment of the invention;

FIGS. 2b-5b and 5c are schematic diagrams illustrating portions of a network element of the network, according to another preferred embodiment of the invention;

FIGS. 6-7 pictorially illustrate a propagation of data packets across a portion of the network element, according to a preferred embodiment of the invention;

FIGS. 8-10 are schematic diagrams illustrating portions of a network element of the network, according to a preferred embodiment of the invention; and

FIGS. 11-12 are flow chart diagram illustrating a method for propagating a data packet, according to preferred embodiments of the invention.

### DETAILED DESCRIPTION OF THE DRAWINGS

The invention provides a method for propagating a data packet from an input port of a network element to an output port of the network element, the network element including a plurality of input ports and a plurality of output ports interconnected by an optical switch, the method including the steps of: (a) receiving the data packet at an input port; (b) processing the data packet to determine a destination output port out of the output ports of the network element; (c) partitioning the data packet to a plurality of fixed sized cells; (d) for each fixed sized cell of the data packet optically transmitting in parallel optical signals to an optical switch, the optical signals being representative of all the bits of the fixed sized cell; (e) switching the optical signals across the optical switch to at least one path leading to the destination output port; (f) reconstructing the data packet from the received optical signals; and (g) providing the data packet to the destination output port.

The invention provides a method for propagating a data packet across network elements along an optical path, each network element along the optical path including a plurality of input ports and a plurality of output ports interconnected by an optical switch, the method including the steps of: (a) receiving the data packet at an ingress network element along the optical path; (b) processing the data packet to determine the optical path; (c) partitioning the data packet to at least one fixed sized cell; (d) generating a WDM optical signal being representative of all the bits of a fixed sized cell, for each fixed sized cell of the data packet; (e) switching WDM signals representative of the data packet across the optical path; and (f) reconstructing the data packet from the WDM signals representative of fixed sized cells belonging to the data packet, at an egress network element along the optical path.

The invention provides a method for propagating a data packet wherein each WDM signal including a plurality of optical signals, each optical signal represents a bit of the fixed sized cell and wherein each optical signal has a single distinct wavelength.

The invention provides a method for propagating a data packet wherein step (f) including they step of converting the WDM signal to a plurality of electrical signals.

The invention provides a method for propagating a data packet wherein step (e) is preceded by a step of configuring the optical switch to switch the WDM signals along the optical path.

The invention provides a method for propagating a data packet wherein step (e) is preceded by the steps of: storing the data packet in an input serial queue out of a plurality of input serial queues, in view of a predefined criterion associated with the content of at least a portion of the data packet; and spreading the bits of fixed sized cells of data packets being located at a top of an input serial queue among a plurality of input parallel queues, for allowing to provide a WDM signal representative of all bits of a fixed sized cell.

The invention provides a method for propagating a data packet, wherein steps (d) and (e) are repeated during consecutive switching cycles of the optical switch.

The invention provides a method for propagating a data packet, wherein each optical signal represents a bit of the fixed sized cell and wherein each optical signal has a single distinct wavelength.

The invention provides a method for propagating a data packet, wherein step (d) is followed by a step of multiplexing the optical signals to provide a wavelength division multiplexed (WDM) signal; wherein step (e) involves switching the WDM signal; and wherein step (e) is followed by a step of converting the WDM signal to a plurality of electrical signals.

The invention provides a method for propagating a data packet wherein each electrical signal being representative of a single bit of the fixed sized cell.

The invention provides a method for propagating a data packet wherein step (e) is preceded by a step of multiplexing the plurality of optical signals to provide a multiplexed wavelength signal; and wherein step (e) is followed by a step of de-multiplexing the wavelength multiplexed signal to provide a plurality of optical bits.

The invention provides a method for propagating a data packet wherein the number of bits within a fixed sized cell substantially equals 2.sub.x, x being a positive integer.

The invention provides a method for propagating a data packet wherein the network element is configured to handle WDM signals of up to J multiplexed optical signals and wherein the number of bits within a fixed sized cell corresponds to J.

The invention provides a method for propagating a data packet wherein further including a step of accumulating data packets to provide a data packet burst; and wherein steps (d) and (e) are repeated until all bits of the data packet burst are switched to the destination output port.

The invention provides a method for propagating a data packet wherein data packet bursts including data packets destined to the same destination group of output ports.

The invention provides a method for propagating a data packet wherein step (f) includes converting the optical signals being received in parallel to a plurality of serially stored electrical signals, wherein the plurality of electrical signal being representative of a fixed sized cell.

The invention provides a method for propagating a data packet wherein step (f) further includes accumulating electrical signals being representative of fixed sized cells of the same data packet to provide a serially stored data packet.

The invention provides a method for propagating a data packet wherein a data packet includes control information for allowing to determine the destination output port.

The invention provides a method for propagating a data packet wherein the network element is configured to read the control information without reading other parts of the data packets.

The invention provides a method for propagating a data packet wherein each optical signal represents a bit of the fixed sized cell and wherein bits of the control information have predefined wavelengths.

The invention provides a method for propagating a data packet from an input port of a network element to an output port of the network element, the network element including a plurality of input ports and a plurality of output ports interconnected by an optical switch, the method including the steps of: (a1) receiving the data packet at an input port; (b1) processing the data packet to determine a destination output port out of the output ports of the network element; (c1) partitioning the data packet to a plurality of fixed sized cells; (d1) for each fixed sized cell belonging to the data packet, optically transmitting in parallel optical signals to an optical switch, the optical signals being representative of all the bits of a fixed sized cell; (e1) switching the optical signals across the optical switch in view of the destination output port, during a single switching cycle; (f1) converting the optical signals to electrical signals being representative of the fixed size cells; (g1) accumulating electrical signals being representative of fixed sized cells of the same data packet to provide a data packet; and (h1) providing the data packet to the destination output port.

The invention provides a method for propagating a data packet wherein step (d1) and (e1) are repeated until all fixed sized cells of the same data packet are switched across the optical switch.

The invention provides a method for propagating a data packet wherein each optical signal represent a bit of the fixed sized cell and wherein each optical signal has a single distinct wavelength.

The invention provides a method for propagating a data packet wherein step (d1) is followed by a step of multiplexing the optical signals to provide a wavelength division multiplexed (WDM) signal; wherein step (e1) involves switching the WDM signal; and wherein step (e1) is followed by a step of converting the WDM signal to a plurality of electrical signals.

The invention provides a method for propagating a data packet wherein each electrical signal being representative of a single bit of the fixed sized cell.

The invention provides a method for propagating a data packet wherein step (e1) is preceded by a step of multiplexing the plurality of optical signals to provide a multiplexed wavelength signal; and wherein step (e1) is followed by a step of de-multiplexing the wavelength multiplexed signal to provide a plurality of optical bits.

The invention provides a method for propagating a data packet wherein the number of bits within a fixed sized cell substantially equals 2.sub.x, x being a positive integer.

The invention provides a method for propagating a data packet wherein the network element is configured to handle WDM signals of up to J multiplexed optical signals and wherein the number of bits within a fixed sized cell corresponds to J.

The invention provides a method for propagating a data packet further including a step of accumulating data packets to provide a data packet burst; and wherein steps (d1) and (e1) are repeated until all bits of the data packet burst are switched to the destination output port.

The invention provides a method for propagating a data packet wherein data packet bursts including data packets destined to the same destination group of output ports.

The invention provides a method for propagating a data packet wherein step (f1) includes converting the optical signals being received in parallel to a plurality of serially stored electrical signals, wherein the plurality of electrical signal being representative of a fixed sized cell.

The invention provides a method for propagating a data packet wherein step (f1) further includes accumulating electrical signals being representative of fixed sized cells of the same data packet to provide a serially stored data packet.

The invention provides a method for propagating a data packet wherein a data packet includes control information for allowing to determine the destination output port.

The invention provides a method for propagating a data packet wherein the network element is configured to read the control information without reading other parts of the data packets.

The invention provides a method for propagating a data packet wherein each optical signal represents a bit of the fixed sized cell and wherein bits of the control information have predefined wavelengths.

The invention provides a method for propagating a data packet wherein the network element is interconnected to at least one network elements to form a network and wherein step (b1) is followed by a step of adding a label being representative of at least a portion of the control information, if the network element acts as an ingress element.

The invention provides a method for propagating a data packet further including a step of removing the label, if the network element acts as an egress element.

The invention provides a method for propagating a data packet from an input port of a network element to an output port of the network element, the network element including a plurality of input ports and a plurality of output ports interconnected by an optical switch, the method including the steps of: (a2) receiving the data packet at an input port; (b2) processing the data packet to determine a destination output port out of the output ports of the network element; (c2) partitioning the data packet to a plurality of fixed sized cells; (d2) for each fixed sized cell, configuring the optical switch to switch in parallel the bits of a fixed sized cell to a destination path leading to the destination output port; (e2) optically transmitting the bits of a fixed sized cell to the optical switch; (f2) switching in parallel the transmitted bits to the destination path; (g2) reconstructing the data packet from the transmitted bits; and (h2) providing the data packet to the destination output port.

The invention provides a method for propagating a data packet wherein step (e2) is preceded by the steps of: storing the data packet in an input serial queue out of a plurality of input serial queues, in view of a predefined criterion associated with the content of at least a portion of the data packet; and spreading the bits of fixed sized cells of data packets being located at a top of an input serial queue among a plurality of input parallel queues, for allowing to provide all bits of a fixed sized cell to the optical switch in parallel.

The invention provides a method for propagating a data packet wherein step (h2) including storing the bits of a fixed sized cell being received in parallel from the optical switch at a plurality of output parallel queues, such that all the bits of the fixed sized cell are aligned; and accumulating bits of the fixed sized cell being stored at the top of output parallel queues to provide the fixed sized cell, for each fixed sized cell of the data packet.

The invention provides a method for propagating a data packet wherein the bits of a fixed sized cell are accumulated at a serial output queue associated with the destination output port of the data packet.

The invention provides a method for propagating a data packet wherein steps (e2) and (f2) are repeated during consecutive switching cycles of the optical switch.

The invention provides a method for propagating a data packet wherein each optical signal represent a bit of the fixed sized cell and wherein each optical signal has a single distinct wavelength.

The invention provides a method for propagating a data packet wherein step (d2) is followed by a step of multiplexing the optical signals to provide a wavelength division multiplexed (WDM) signal, step (f2) including switching the WDM signal; and wherein step (f2) is followed by a step of converting the WDM signal to a plurality of electrical signals.

The invention provides a method for propagating a data packet wherein each electrical signal being representative of a single bit of the fixed sized cell.

The invention provides a method for propagating a data packet wherein step (f2) is preceded by a step of multiplexing the plurality of optical signals to provide a multiplexed wavelength signal; and wherein step (f2) is followed by a step of de-multiplexing the wavelength multiplexed signal to provide a plurality of optical bits.

The invention provides a method for propagating a data packet wherein the number of bits within a fixed sized cell substantially equals 2.sub.x, x being a positive integer. 2.sub.x being 2^{x} (2 by the power of x).

The invention provides a method for propagating a data packet wherein the network element is configured to handle WDM signals of up to J multiplexed optical signals and wherein the number of bits within a fixed sized cell corresponds to J.

The invention provides a method for propagating a data packet further including a step of accumulating data packets to provide a data packet burst; and wherein steps (e) and (f) are repeated until all bits of the data packet burst are switched to the destination output port.

The invention provides a method for propagating a data packet wherein data packet bursts including data packets destined to the same destination group of output ports.

The invention provides a method for propagating a data packet wherein step (h) including converting the optical signals being received in parallel to a plurality of serially stored electrical signals, wherein the plurality of electrical signal being representative of a fixed sized cell.

The invention provides a method for propagating a data packet wherein step (h) further including accumulating electrical signals being representative of fixed sized cells of the same data packet to provide a serially stored data packet.

The invention provides a method for propagating a data packet wherein a data packet includes control information for allowing to determine the destination output port.

The invention provides a method for propagating a data packet wherein the network element is configured to read the control information without reading other parts of the data packets.

The invention provides a method for propagating a data packet wherein each optical signal represents a bit of the fixed sized cell and wherein bits of the control information have predefined wavelengths.

The invention provides a network element including: a plurality of input ports, each input port is configured to: (a) receive data packets associated with destination output ports of the network element, and (b) process at least a portion of each data packet to determine the destination output port associated with the data packet; a plurality of serial to parallel converters, coupled to the plurality of input ports and to an optical switch, each serial to parallel converter is configured to receive a data packet, to segment the data packet to at least one fixed sized cell and to provide the bits of each fixed size cell in parallel to an optical switch; an optical switch module for switching all bits of a fixed size cell in parallel to parallel to serial converters; and a plurality of parallel to serial converters, coupled to the optical switch module and coupled to a plurality of output ports of the network element, the parallel to serial converters are configured to receive the bits of fixed sized cells in parallel and to provide data packets to the plurality of output ports.

The invention provides a network element wherein the optical switch module is configured to switch consecutive fixed size cells belonging to the same data packet during consecutive switching cycles.

The invention provides a network element wherein the serial to parallel converters provide electrical signals to the optical switch module; and wherein the optical switch module including: a plurality of electrical to optical converters, for converting the electrical signals to optical signals, each optical signal being representative of a bit of the fixed sized cell; an plurality of multiplexers, coupled to a plurality of electrical to optical converters, each multiplexer for multiplexing optical signals being representative of the bits of a fixed sized cell to a single WDM signal; an optical switch, coupled to the plurality of multiplexers and to a plurality of de-multiplexers, for switching the single WDN signal in view of the destination output port; a plurality of de-multiplexers, coupled to the optical switch, for receiving the single WDM signal and splitting the WDM signal to a plurality of optical signals; and a plurality of optical to electrical converters, for converting the optical signals to electrical signals, each electrical signal being representative of a bit of the fixed sized cell.

The invention provides a network including a plurality of network elements interconnected by optical links, at least one network element being an ingress network element, at least one network element being an egress network element, at least one network element being an intermediate network element, the network is configured to accommodate a plurality of optical paths between ingress and egress network elements; an ingress network element including: a plurality of input ports, each input port is configured to receive data packets and process at least a portion of each data packet to determine the destination output port associated with the data packet; a plurality of serial to parallel converters, coupled to the plurality of input ports and to an optical switch, each serial to parallel converter is configured to receive a data packet, to segment the data packet to at least one fixed sized cell and to generate WDM signals, each WDM signal representative of a fixed size cell; and an optical switch module for switching WDM signals in view of the optical path of the data packet.

The invention provides a network wherein an egress network element including a plurality of parallel to serial converters, adapted to receive the WDM signals, and to reconstruct a data packet from WDM signals representative of fixed sized cells belonging to the data packet.

The invention provides a network wherein intermediate network elements are configured to switch WDM signals across the optical path.

The invention provides a network wherein the optical switch module is configured to switch consecutive fixed size cells belonging to the same data packet during consecutive switching cycles.

The invention provides a network wherein the serial to parallel converters provide electrical signals to the optical switch module; and wherein the optical switch module including: a plurality of electrical to optical converters, for converting the electrical signals to optical signals, each optical signal being representative of a bit of the fixed sized cell; an plurality of multiplexers, coupled to a plurality of electrical to optical converters, each multiplexer for multiplexing optical signals being representative of the bits of a fixed sized cell to a WDM signal; an optical switch, coupled to the plurality of multiplexers and to a plurality of de-multiplexers, for switching the WDN signal in view of the optical path.

The invention provides a network wherein an egress network element further including a plurality of de-multiplexers, for receiving the WDM signal and splitting the WDM signal to a plurality of optical signals; and a plurality of optical to electrical converters, for converting the plurality of optical signals to a plurality of electrical signals, each electrical signal being representative of a bit of the fixed sized cell.

The invention provides a network wherein each optical signal being representative of a single bit of the fixed sized cell.

The invention provides a network wherein the number of bits within a fixed sized cell substantially equals 2.sub.x, x being a positive integer.

The invention provides a network wherein network elements are configured to handle WDM signals of up to J multiplexed optical signals and wherein the number of bits within a fixed sized cell corresponds to J.

The invention provides a network wherein an ingress network element further including at least one burst generator for accumulating data packets to provide a data packet burst.

The invention provides a network wherein all the bits of a data packet burst are switched continuously.

The invention provides a network wherein the burst generator including an input crossbar coupled to a plurality of input serial queues.

The invention provides a network wherein data packets provided to the input crossbar are sent to an input serial queue out of the plurality of input serial queues, in view of a predefined criterion associated with the content of at least a portion of the data packets.

The invention provides a network wherein the serial to parallel converters including: a plurality of input parallel queues, wherein each input parallel queue is coupled to a single input port of the optical switch module, for providing a single bit to the optical switch module; and a spreading unit, coupled to the plurality of output parallel queues and to the plurality of input serial queues, for spreading the bits of fixed sized cells of data packets being located at a top of input serial queues among the plurality of input parallel queues.

The invention provides a network wherein an egress network element further including: a plurality of output parallel queues, for storing the bits of a fixed sized cell being received in parallel from the optical switch module; and an accumulator, coupled to the plurality of output parallel queues and to the plurality of output ports, for accumulating bits of fixed sized cell being stored at the top of output parallel queues to provide a serially stored fixed size cell.

The invention provides a network element wherein each of the optical signals being representative of a single bit of the fixed sized cell.

The invention provides a network element wherein the number of bits within a fixed sized cell substantially equals 2.sub.x, x being a positive integer.

The invention provides a network element wherein the network element is configured to handle WDM signals of up to J multiplexed optical signals and wherein the number of bits within a fixed sized cell corresponds to J.

The invention provides a network element wherein the plurality of input ports further including at least one burst generator for accumulating data packets to provide a data packet burst.

The invention provides a network element wherein all the bits of a data packet burst are switched continuously.

The invention provides a network element wherein the burst generator including an input crossbar coupled to a plurality of input serial queues.

The invention provides a network element wherein data packets provided to the input crossbar are sent to an input serial queue out of the plurality of input serial queues, in view of a predefined criterion associated with the content of at least a portion of the data packets.

The invention provides a network element wherein the serial to parallel converters including: a plurality of input parallel queues, wherein each input parallel queue is coupled to a single input port of the optical switch module, for providing a single bit to the optical switch module; and a spreading unit, coupled to the plurality of output parallel queues and to the plurality of input serial queues, for spreading the bits of fixed sized cells of data packets being located at a top of input serial queues among the plurality of input parallel queues.

The invention provides a network element further including: a plurality of output parallel queues, coupled to the optical switch module, for storing the bits of a fixed sized cell being received in parallel from the optical switch module; and an accumulator, coupled to the plurality of output parallel queues and to the plurality of output ports, for accumulating bits of fixed sized cell being stored at the top of output parallel queues to provide a serially stored fixed size cell.

According to an aspect of the invention at least some of the bits of fixed sized cell are used as error correction bits, for allowing for reconstructing erroneous bits. For example, a predefined bit of each fixed sized cell reflects a logic XOR operation applied on the other bits of the fixed sized cell. Accordingly, if one of the bits is erroneous, or is not detected/received properly the other bits of the fixed sized cell, including the predefined bit can be used to reconstruct the erroneous bit.

It should be noted that the particular terms and expressions employed and the particular structural and operational details disclosed in the detailed description and accompanying drawings are for illustrative purposes only and are not intended to in any way limit the scope of the invention as described in the appended claims.

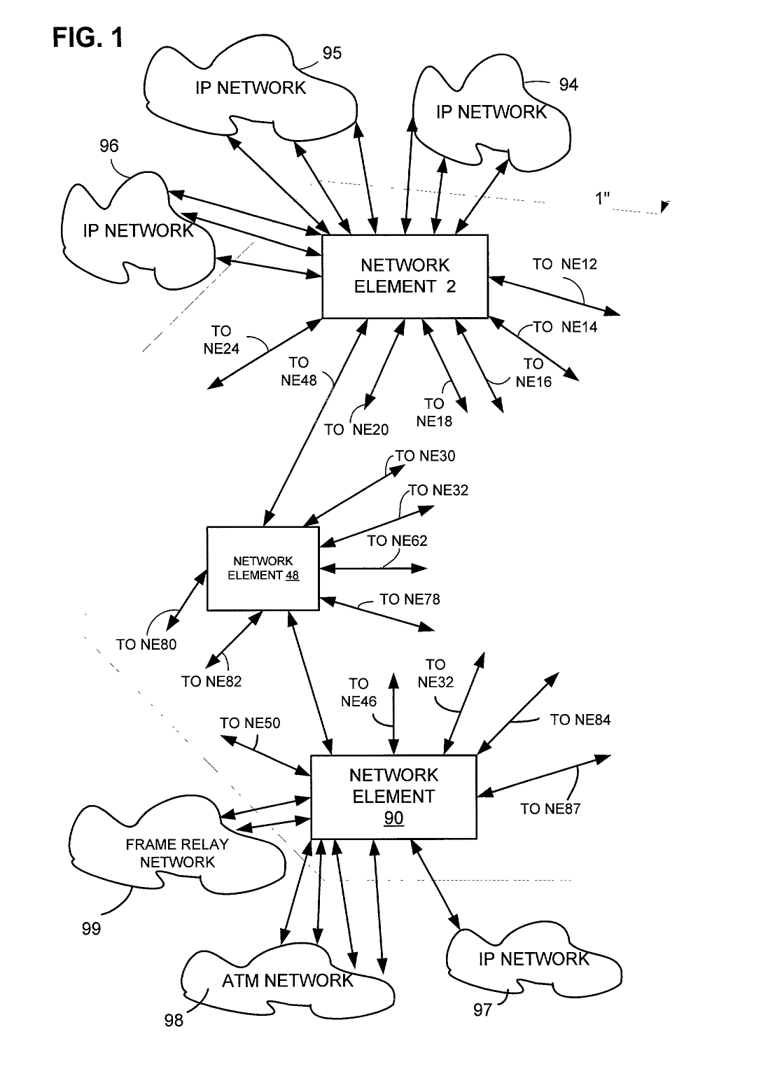

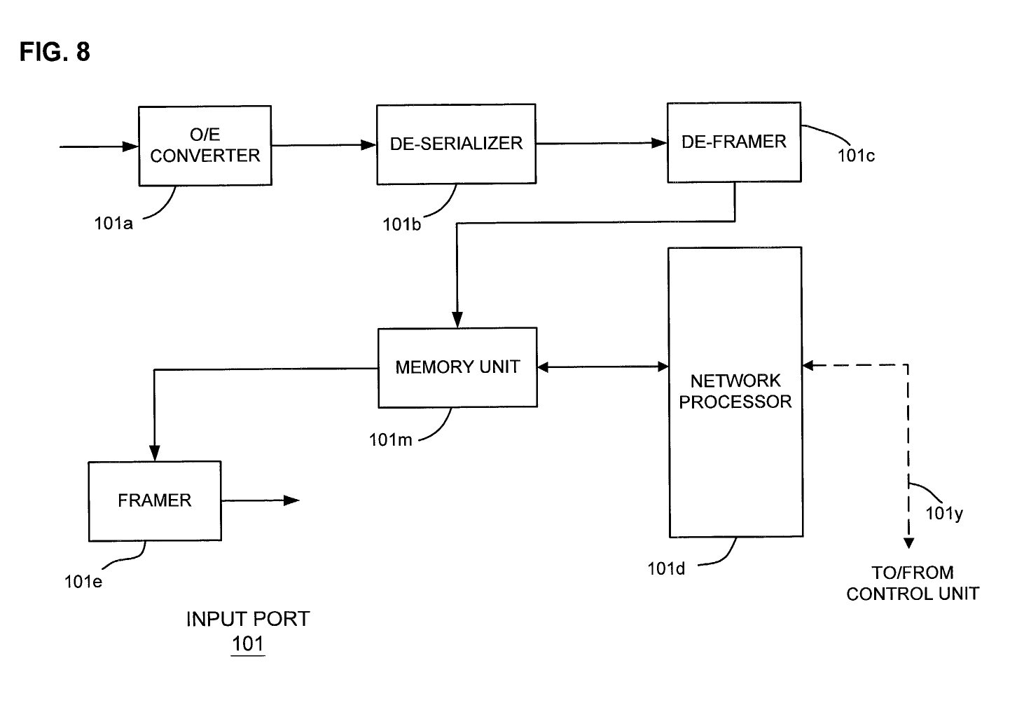

FIG. 1 illustrates a portion 1″ of wavelength division multiplexing (WDM) network 1 that is interconnected to a plurality of networks such as IP networks 94, 95 and 96, frame relay network 99, ATM network 98 and IP network 97, according to a preferred embodiment of the invention. Portion 1″ includes network elements such as network elements 2, 48 and 90. Network element 2 is interconnected via optical links to IP networks 94, 95 and 95 via sixty four I/O ports and is interconnected to network elements 24, 48, 20, 18, 16, 14 and 12 via seven I/O ports. Network element 48 is interconnected to network elements 30, 32, 62, 78, 80, 82 and 90 via eight I/O ports. Network element 90 is interconnected to IP network 97, ATM network 98 and frame relay 99 via sixty four I/O ports and is interconnected to network elements 32, 46, 48, 50, 84 and 87 via seven I/O ports. The network elements of network 1 are interconnected by optical links and are configured to exchange WDM optical signals, and/or additional control, status and routing information. Network 1 further includes a central system management unit (not shown), although it can be managed by distributed management schemes. Network element 10 includes a network control component (not shown), for establishing optical path across a network including the network element. The network control element is coupled either to the central system management unit or to network components of other network elements. Network element 2 further includes a local control component, such as network processors illustrated at FIGS. 8-10.

Network elements of network 1 have two types of input/output (I/O) ports. I/O ports of the first type are configured to exchange single wavelength signals. I/O ports of the second type are configured to exchange WDM signals. For convenience of explanation, each of the second type I/O port is referenced by two numbers, a first denoting the input portion of the I/O port and the second denoting the output portion of the I/O port.

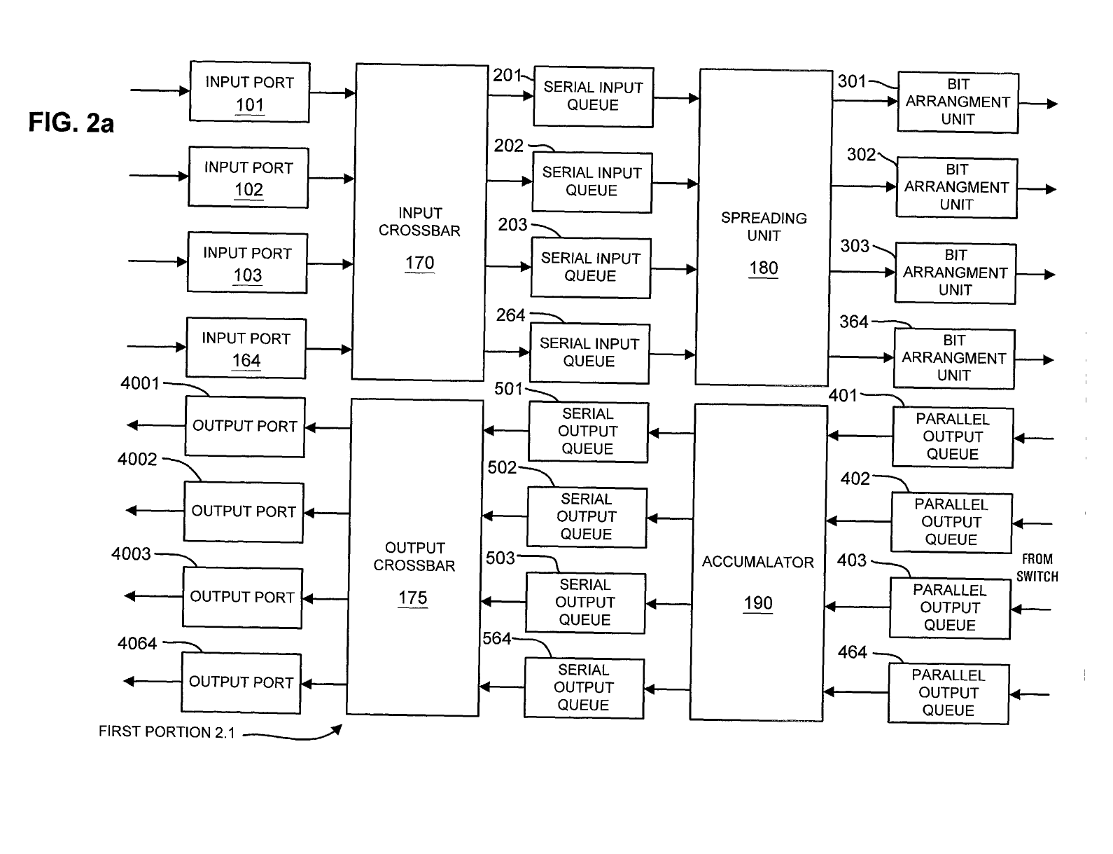

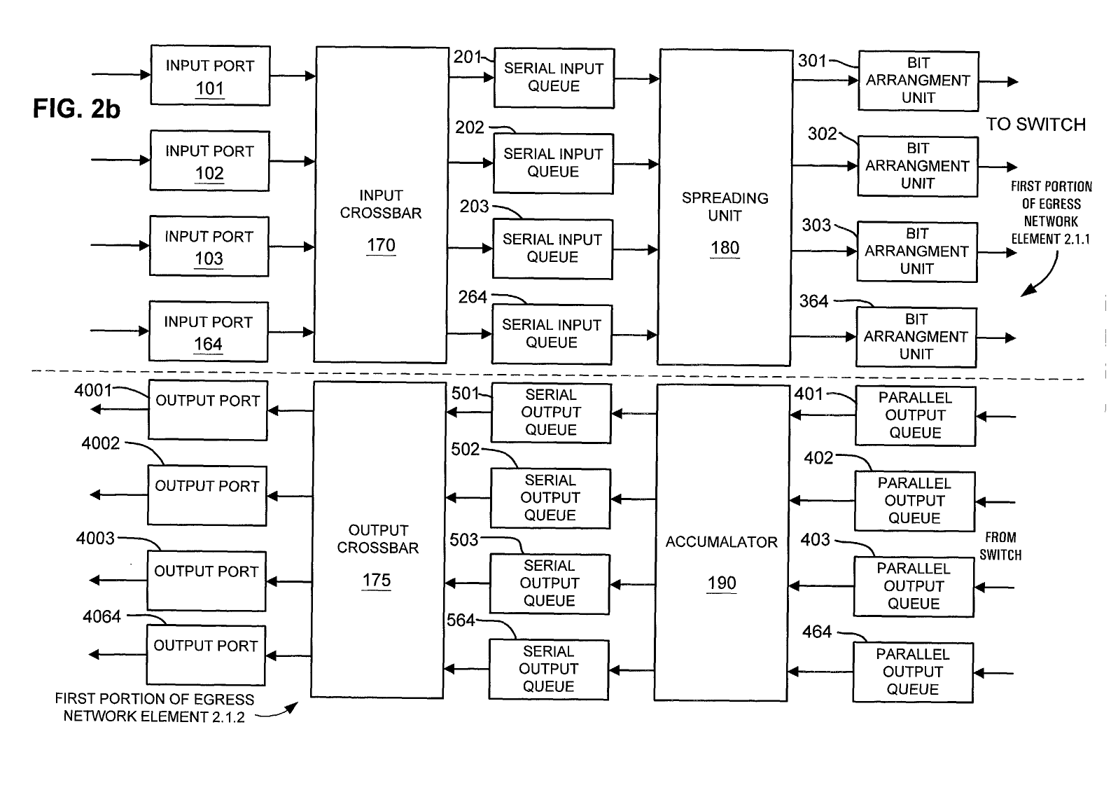

FIGS. 2a-5 illustrate an exemplary network element in which an optical representation of a data packet undergoes an optical to electrical conversion, an electrical to optical conversion, an optical to electrical conversion and than an electrical to optical conversion. Nevertheless, the invention is not limited to this sequence of conversions and not limited to the scope of each conversion. For example, only a portion of the optical representation of the data packet can be converted to an electrical signal for allowing to determine the data packet destination and to forward the data packet accordingly. Accordingly, various units and/or logic circuits that are adapted to handle electrical signals can be replaced by units and logic circuits adapted to handle optical signals.

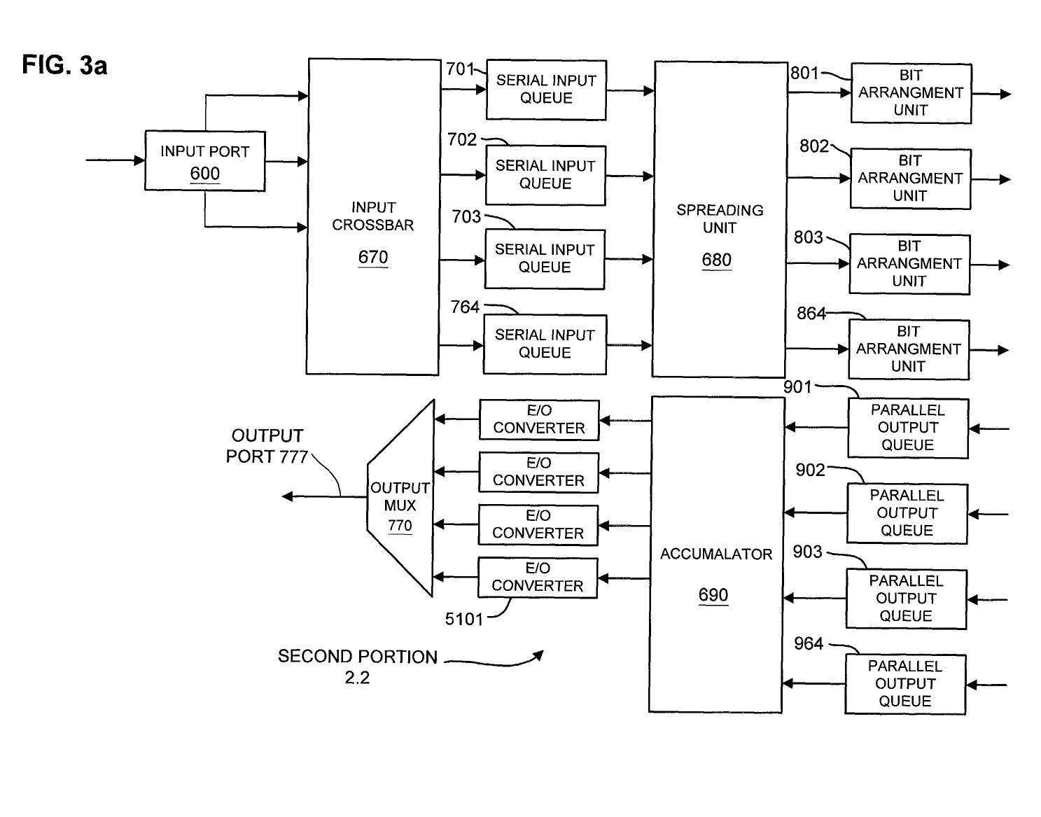

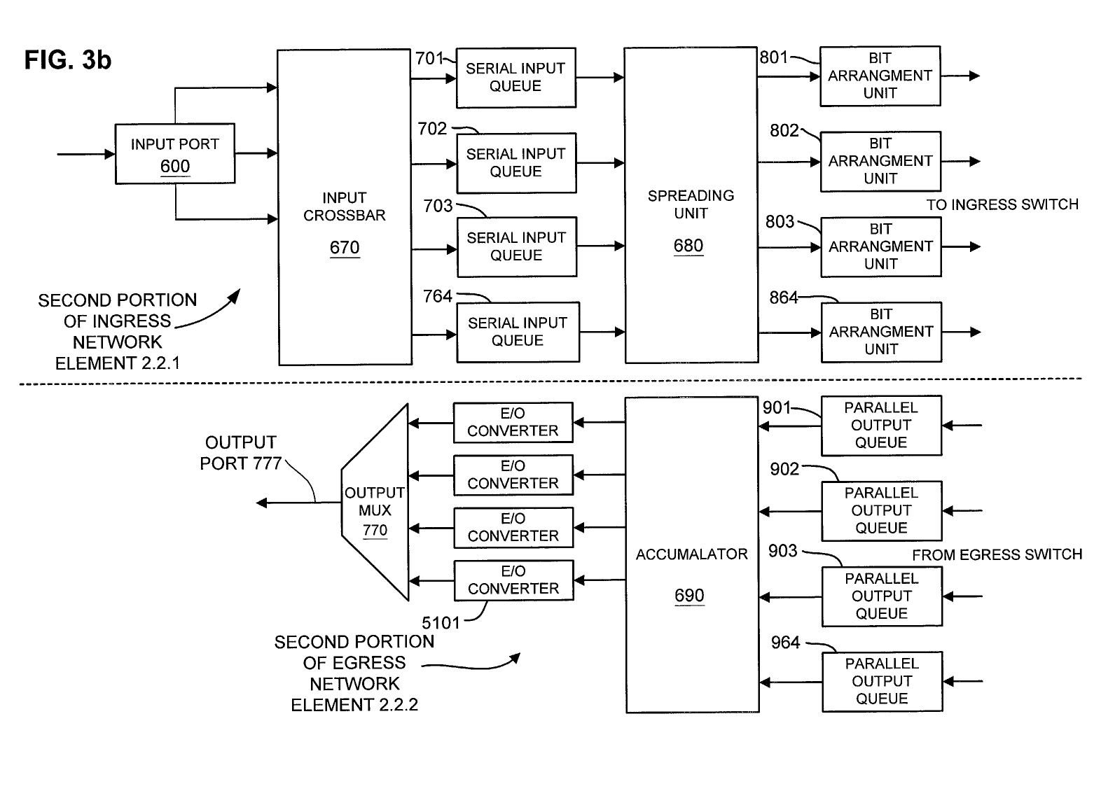

As illustrated at FIG. 2a, network element 2 has sixty four input/output (I/O) ports for exchanging single wavelength signals with IP networks 94, 95 and 96. These sixty four I/O ports are shown at FIG. 2a as input ports 101-164 and output ports 4001-4064. Network element 2 has seven I/O ports for receiving and transmitting WDM optical signals, each WDM signal of up to sixty four multiplexed optical signals of sixty four wavelengths. Two I/O ports out of these seven are shown at FIGS. 2 and 3 as input port 600 and output port 777, input port 3600 and output port 3777. The other five I/O ports are analogues to each of these two I/O ports.

Optical paths across network 1 are established and maintained by either a central or distributed management schemes. An optical path is a path through which a data packet propagates, wherein during at least a portion of the optical path the data packet is represented by an optical signal. Across an optical path the at least one optical signal representing the data packet or a portion of the data packet can be converted to at least one electrical signal and vice verse.

When a router from an external network, such as an IP network, sends data packets that are destined to a router of another IP network, each data packet is received at an ingress network element of the network 1, is sent along an optical path until reaching an egress network element to be provided to the other IP network. For example, assuming that a router from IP network 94 sends a data packet to another router of IP network 97. The data packet includes an IP header that indicates what are the source and the destination of the data packet. The data packet arrives to network element 2, acting as an ingress network element, interconnected to IP network 94. Network element 2 will perform an IP forwarding process to select an optical path across network 1 that ends at network element 90, network element 90 being interconnected to IP network 97.

FIGS. 2-5 illustrate portions of network element 2, according to a preferred embodiment of the invention. Network element 2 has a plurality of input ports, a plurality of serial to parallel converters such as spreading unit 180 and bit arrangement units 301-364, optical switch module 5555 and a plurality of parallel to serial converters such as accumulator 190 and serial output queues 501-564. Optionally, network element 2 further has burst generators such as input crossbar 170 and serial input queues 201-264.

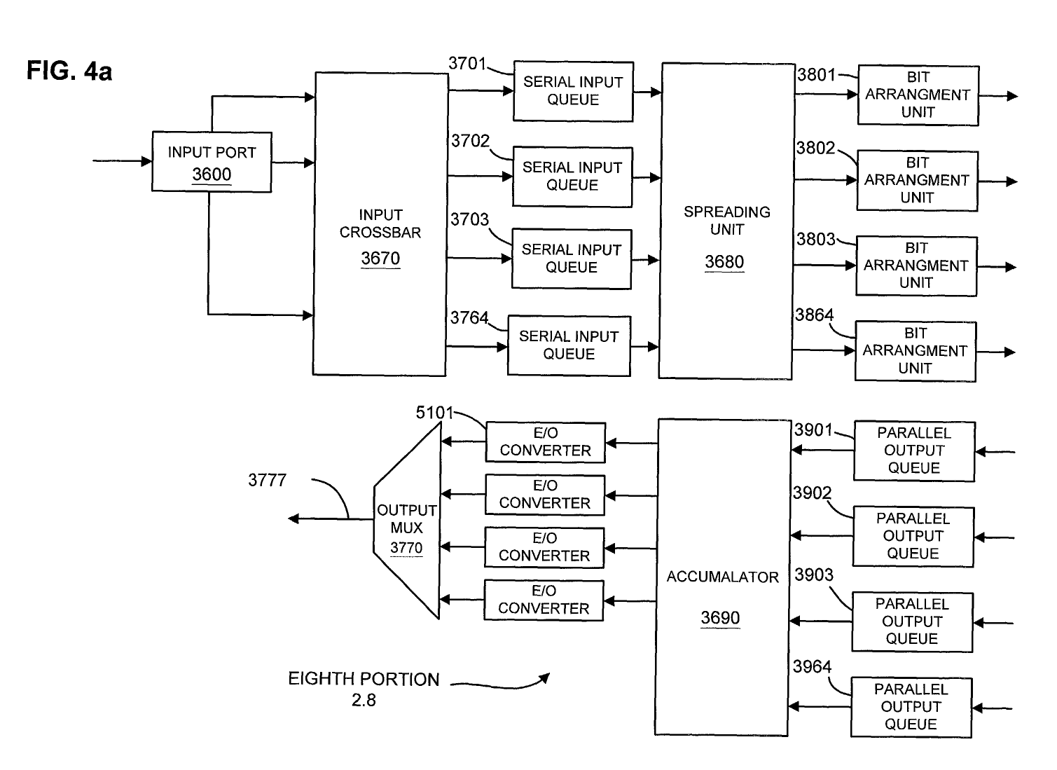

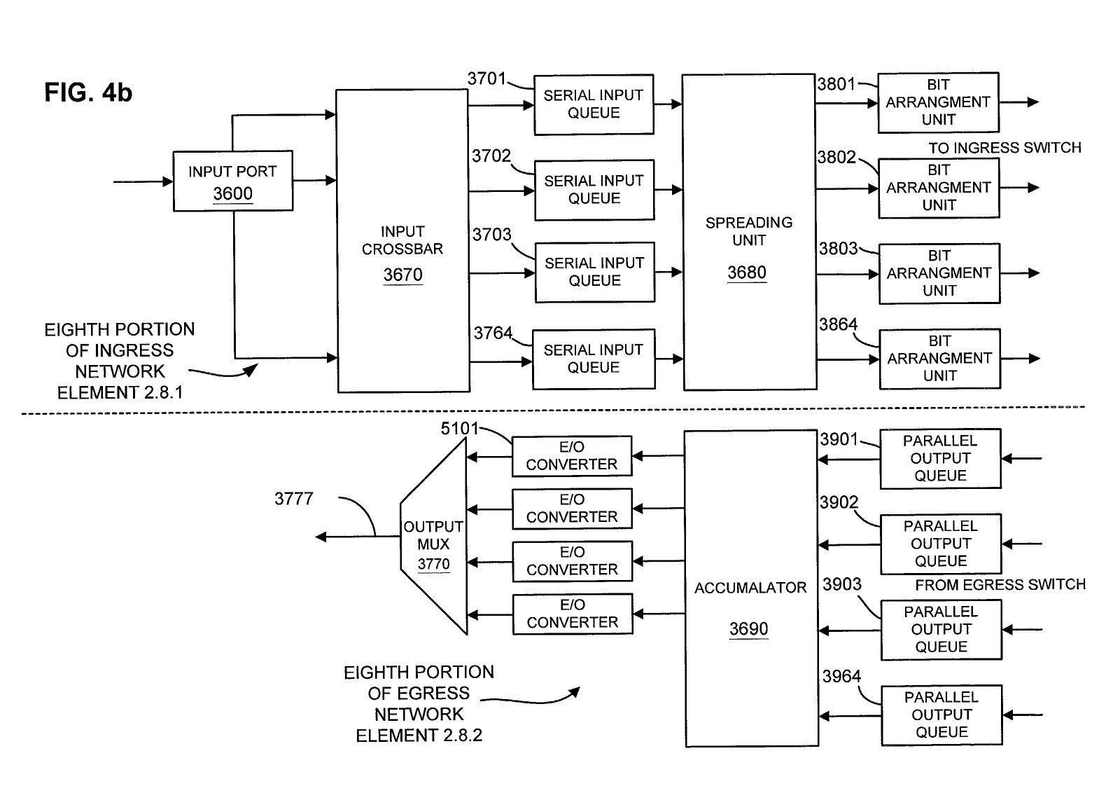

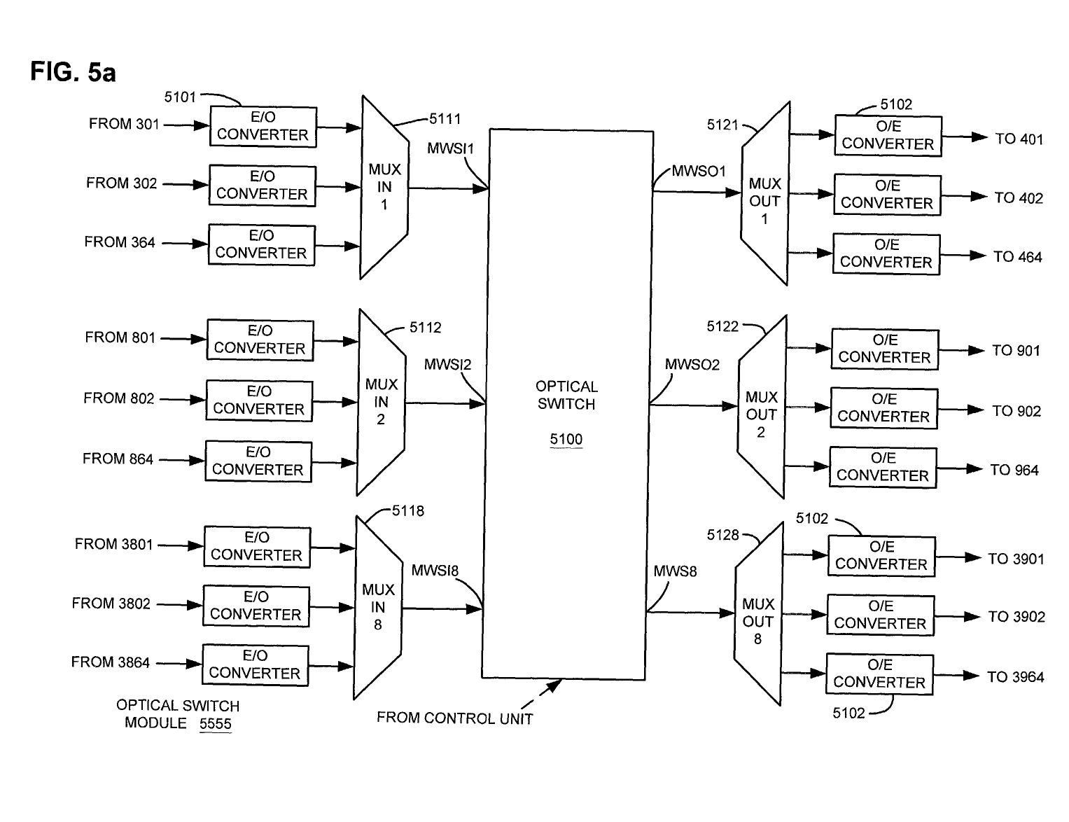

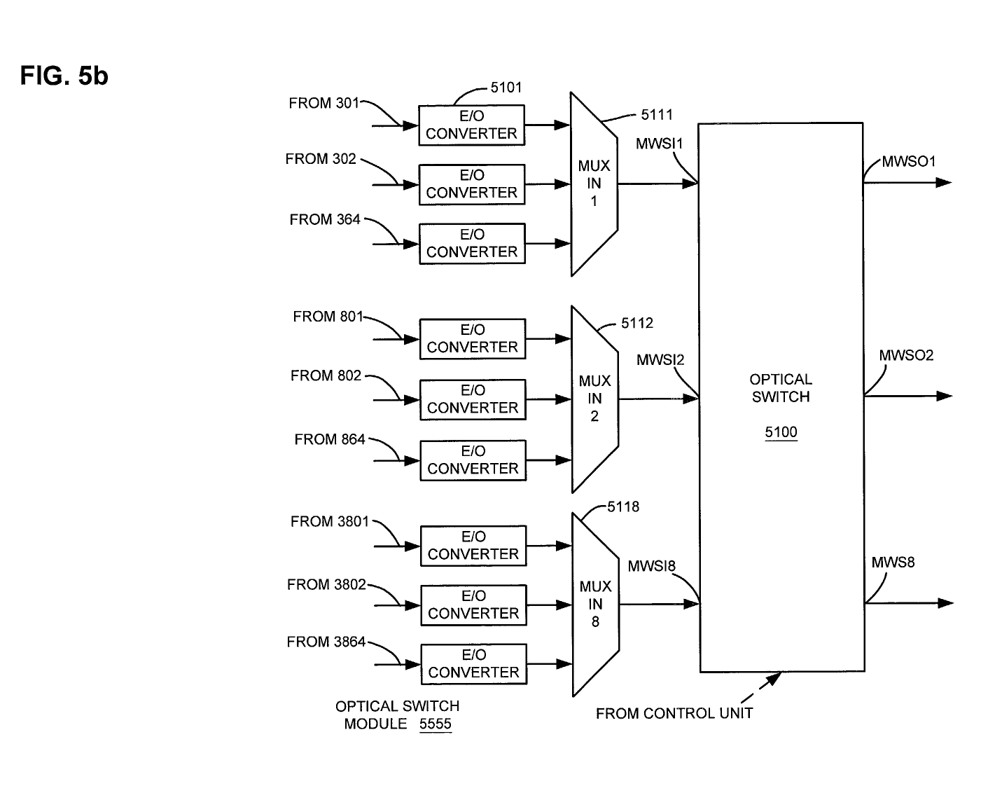

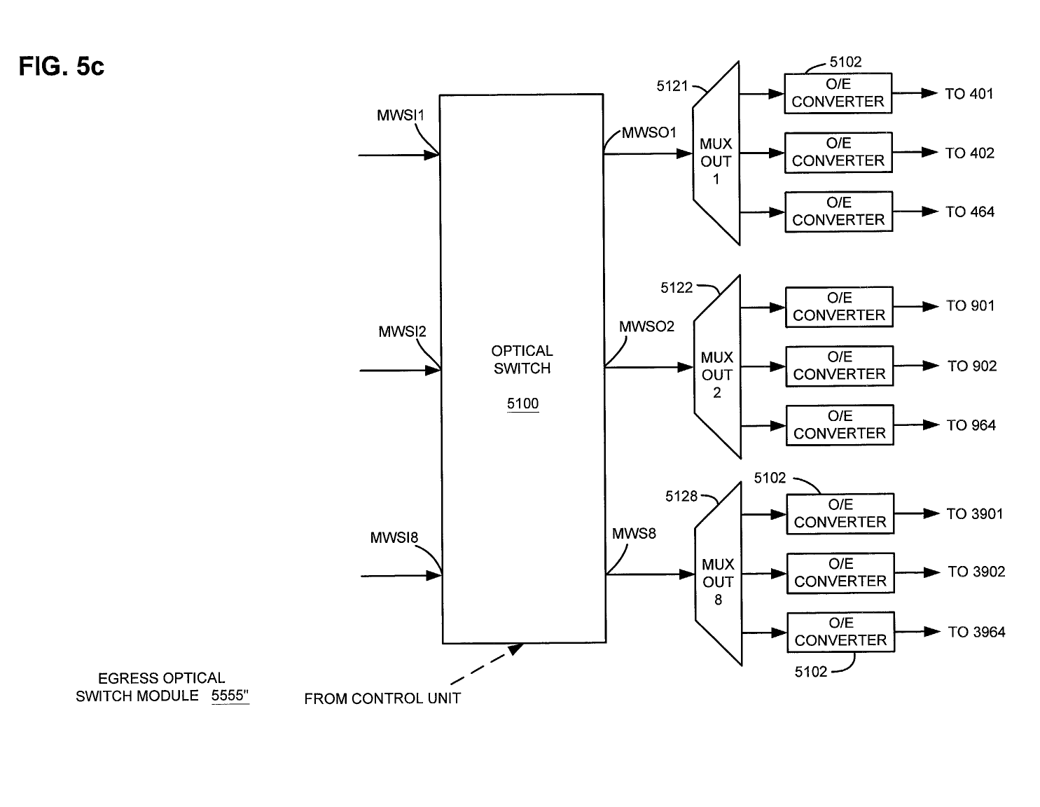

FIG. 2a illustrates first portion 2.1 of network element 2. First portion 2.1 is configured to receive and transmit single wavelength signals from and to IP networks 94-96. FIG. 3a illustrates second portion 2.2 of network element 2. Second portion 2.2 is configured to receive and transmit wavelength division multiplexed signals from and to network element 12 denoted NE12 at FIG. 1. FIG. 4 illustrates eighth portion 2.8 of network element 2. Eighth portion 2.8 of network element 2 is configured to receive and transmit wavelength division multiplexed signals from and to network element 48. The third till seventh portions of network element are analogues to each one of second portion 2.2 and eighth portion 2.8 of network element 2. All eight portions are configured to receive and transmit signals to optical switch module 5555 of FIG. 5a.

Network element 2 has at least one control entity for controlling the propagation of data packets, fixed sized cells of data packets and bits of the fixed sized cells across network element 2. Conveniently, each portion out of portions 2.2-2.8 has at least one local control unit for controlling the burst generation, the segmentation of data packets and the serial to parallel conversion, while a central control unit controls the configuration of optical switch 5100 (shown at FIG. 5a) and the provision of signals to optical switch module 5555.

First portion 2.1 includes input ports 101-164, input crossbar 170, output crossbar 175, serial input queues 201-264, spreading unit 180, bit arrangement units 301-364, parallel output queues 401-464, accumulator 190, serial output queues 501-564 and output ports 4001-4064.

Each of input ports 101-164 is configured to receive data frames including data packets and for each data packet to process at least a portion of the data packet to determine to which serial input queue to send the data packet. Said determination is based upon various parameters, such as the destination output port, the flow to which the data packet belongs.

Input ports 101-164 are coupled to the local control unit that is configured to control the propagation of data packets across input crossbar 170. Input crossbar 170 interconnects input ports 101-164 to serial input queues 201-264. For convenience of explanation it is assumed that each serial input queue stores data packets destined to the same output port or the same group of output ports, and that the number of input serial queues equals the number of input ports, but this is not necessary. As illustrated by FIG. 5a, output ports 4001-4064 are regarded as a group of output ports, while each of the output ports of the second till eighth portions 2.2-2.8 is regarded as a group. As the number of serial input ports largely exceeds the number of groups, data packets destined to the same group can be sent to different serial input queues. Conveniently, the data packets are evenly distributed between the various serial input queues. Preferably, data packets that belong to the same flow of data packets are provided to the same serial input queue.

The local control unit is configured to receive requests to send data packets across input crossbar to serial input queues, determine which requests to accept, send control signals to the input ports and configure input crossbar 170 such that the accepted requests are serviced.

Conveniently, each serial input queue out of queues 201-264 accumulate data packets destined to the same group of destination output port to provide data packet bursts. The continuous switch of the fixed sized cell belonging to the same data packet burst requires a single configuration of the optical switch, thus improving the utilization of the optical switch and reducing the number of configuration sessions.

Spreading unit 180 is coupled to serial input queues 201-264 and to bit arrangement units 301-364 for allowing a partition of each data packet to at least one fixed sized cell and for converting a serially stored fixed sized cell of sixty four bits to sixty four bits that are stored in parallel in bit arrangement units 301-364. According to another aspect of the invention, idle bits are added to data packets such that the size of the data packet exactly match a product of sixty four. These idle bits are removed before the data packet exits network 1.

Spreading unit 180 (i) fetches sixty four bits of a data packet forming a fixed sized cell from a serial input queue out of serial input queues 201-264, and (ii) provides distinct bits to distinct bit arrangement units out of bit arrangement units 301-364. Spreading unit 180 fetches the sixty four bits according to a predefined scheme. For example, according to one scheme, spreading unit 180 skips empty queues, and according to another scheme spreading unit 180 does not skip these queues. The former scheme improves the utilization of the network element but complicates the management and reordering of the bits. According to another predefined scheme, spreading unit sequentially fetches the bits of fixed sized cells until a data packet is fetched from a serial input queue. Just than bits from another data packet are fetched. This scheme simplifies the provision of bits belonging to the same data packet to switching module 5555.

For convenience of explanation it is assumed that spreading unit 180 sequentially access serial queues, starting at serial input queue 201 and ending at serial input queue 264.

Bit arrangement units are configured to receive bits from different serial input queues out of 201-264 via spreading unit 180 and either rearrange the bits or control the provision of bits to optical switch module 5555 to allow the consecutive transmission of fixed sized cells belonging to the same data packet or to the same data packet burst during consecutive switching cycles of optical switch module 5555.

Referring to FIG. 5a there is illustrated optical switch module 5555, according to a preferred embodiment of the invention. Optical switch module 5555 includes E/O converters 5101, multiplexers 5111-5118, optical switch 5100, de-multiplexers 5121-5128, and O/E converters 5102. Optical switch 5100 has eight inputs MWSI1-MWSI8 and eight outputs MWSO1-MWSO8 and a control input. Inputs MWSI1-MWSI8 are coupled to multiplexers 5111-5118 respectively for receiving WDM signals representative of fixed sized cells from first to eighth portions 2.1-2.8 accordingly. Outputs MWSO1-MWSO8 are coupled to de-multiplexers 5121-5128 respectively for providing signals destined to output ports within first to eighth portion 2.1-2.8 respectively. Each multiplexer has sixty four inputs, each input is coupled to an E/O converter 5101 such that each multiplexer receives in parallel sixty four optical signals and converts them to a single WDM signal. The WDM signal is provided to optical switch 5100 and switched according to control signals provided to the E/O converters and optical switch 5100 by a control unit. Each de-multiplexer out of de-multiplexers 5121-5128 is coupled to sixty four O/E converters 5102, each configured to convert an optical signal to an electrical signal.

Bit arrangement units 301-364 are coupled to a plurality of electrical to optical converters, such as E/O converter 5101, for generating optical signal reflecting the bits provided by bit arrangement units 301-364.

Each bit of the fixed sized cell is carried on a single distinct wavelength, thus allowing all sixty four signals to be multiplexed by a multiplexer out of multiplexers 5111-5118 to provide a WDM signal. The WDM signal is provided to optical switch 5100 that switches the WDM signal to local paths leading to the destination output port. Accordingly, all sixty four bits are switched in parallel, and conveniently during a single switching cycle.

According to a preferred embodiment of the invention, fixed sized cells belonging to the same data packet or to the same data packet burst are sequentially provided to optical switch module 5555, thus allowing to reduce the amount and/or frequency of optical switch 5100 configurations.

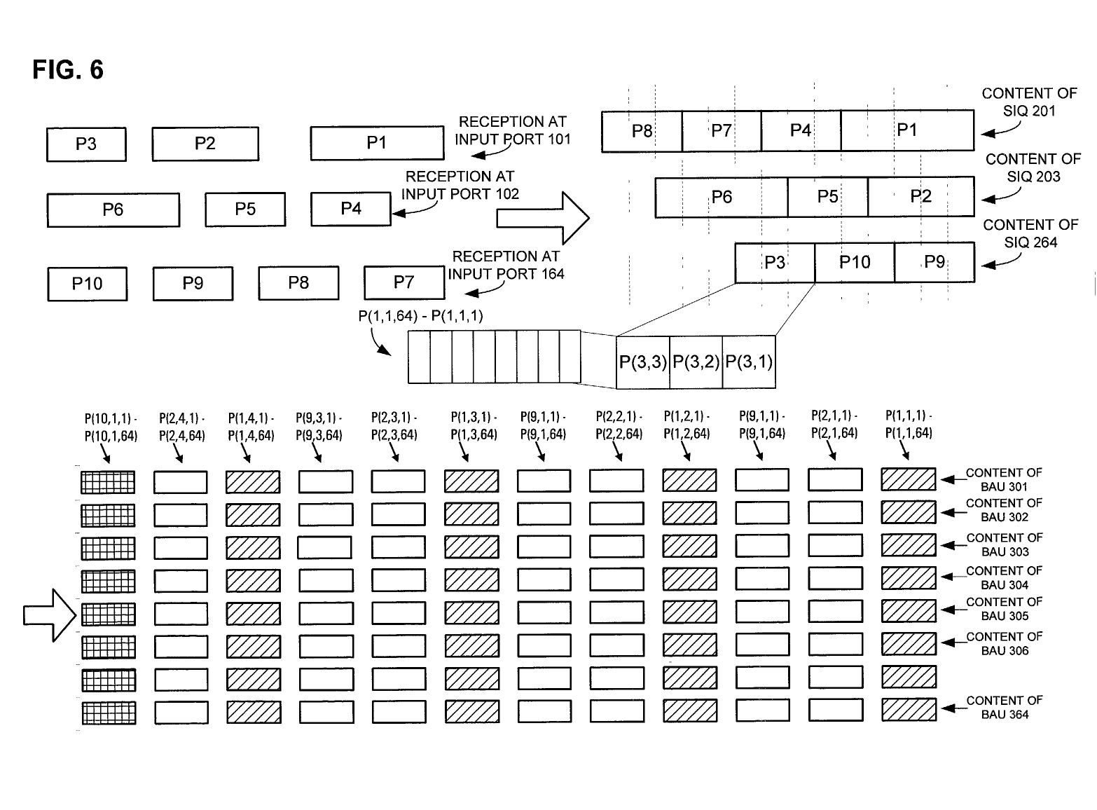

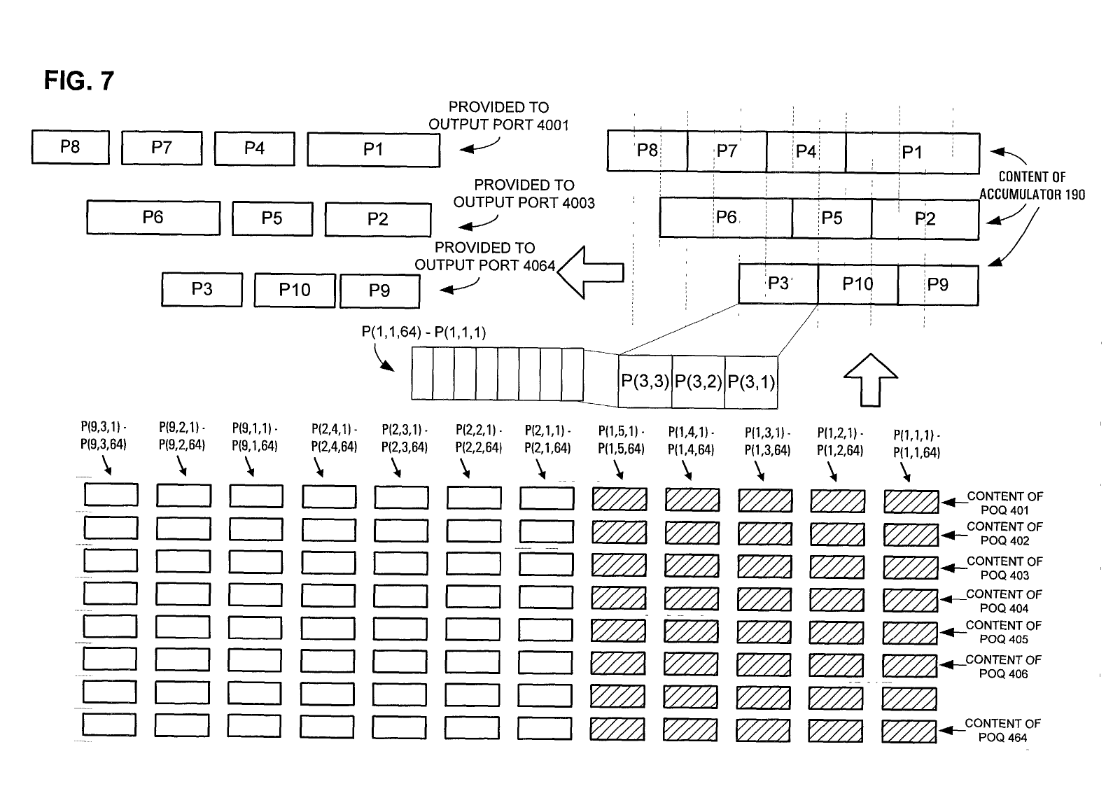

Referring to FIGS. 6 and 7, there is illustrated a propagation of data packets across first portion 2.1 and optical switch module 5555. Packets P1, P2 and P3 are received at input port 101, packets P4, P5 and P6 are received at input port 102 and packets P7, P8, P9 and P10 are received at input port 164. Packets P1, P4, P7 and P8 are destined to output port 4001 and accordingly are sent via input crossbar 170 to serial input queue 201. Packets P2, P5 and P6 are destined to output port 4003 and accordingly are sent to serial input queue 203. Packets P9, P10 and P3 are destined to output port 4064 and accordingly are sent to serial input queue 264. As illustrated by the vertical dashed lines, each of packets P1 and P6 include five fixed sized cells P(1,1)-P(1,5) and P(6,1)-P(6,5) accordingly, packet P2 includes four fixed sized cells P(2,1)-P(2,4), and each of packets P3, P4, P5, P7, P8, P9 and P10 includes three fixed sized cells P(3,1)-P(3,3), P(4,1)-P(4,3), P(5,1)-P(5,3), P(7,1)-P(7,3), P(8,1)-P(8,3), P(9,1)-P(9,3), and P(10,1)-P(10,3) accordingly. Each fixed sized cell includes sixty four bits, P(pn,cn,1)-P(pn,cn,64), pn denotes the packet serial number and ranges between 1 to 10, cn denotes the fixed sized cell serial number.

The lower part of FIG. 6 illustrates the content of some bit arrangement units out of bit arrangement units 301-364. The bits of each fixed sized cells are provided to the bit arrangement units by spreading unit 180. The content of distinct bit arrangement units are separated by horizontal dashed lines. Bits of the same fixed sized cell are aligned. Assuming that all serial input queues except serial input queues 201, 203 and 264 are empty, then spreading unit 180 sequentially fetches bits from these queues, starting at serial input queue 201, then each of the bit arrangement units stores a bit from the following fixed sized cells: P(1,1), P(2,1), P(9,1), P(1,2), P(2,2), P(9,2), P(1,3), P(2,3), P(9,3), P(1,4), P(2,4), P(10,1) and so on.

Bit arrangement units 301-364 provide to optical switch module 5555 consecutive fixed sized cells during consecutive switching cycles of optical switch 5100. The lower part of FIG. 7 reflects a portion of the content of parallel output queues 401-464. Bits from consecutive fixed sized cells of the same data packet are continuously stored within parallel output queues 401-464. Accordingly, bits from fixed sized cell P(1,1) are followed by bits from the following fixed sized cells: P(1,2), P(1,3), P(1,4), P(1,5), P(2,1), P(2,2), P(2,3), P(2,4), P(9,1), P(9,2), P(9,3), P(4,1) and so on.

The bits of each fixed sized cell are fetched from the sixty four parallel output queues 401-464 by accumulator 190 and are serially arranged and stored, as illustrated by the upper right side part of FIG. 7. Data packets P1, P4, P7 and P8 are sent to output port 4001 via output crossbar 175. Data packets P2, P5 and P6 are sent to output port 4003 via output crossbar 175. Data packets P9, P10 and P3 are sent to output port 4064 via output crossbar 175.

Referring to FIG. 2a, the bits of fixed sized cells that are destined to an output port out of the group of output ports 4001-4064 are provided in parallel to parallel output queues 401-464. Parallel output queues 401-464 are coupled to accumulator 190 for accumulating bits of a fixed sized cell from all parallel output queues 401-464 to provide serially stored fixed sized cells.

Conveniently, accumulator 190 accumulates fixed sized cells of the same data packet to provide serially stored data packets, though the latter accumulation can be done at a serial output queue out of serial output queues 501-564 coupled to accumulator 190. Serial output queues 501-564 are coupled to output ports 4001-4064 via output crossbar 175 for allowing an efficient provision of data packets stored at serial output queues 501-564 to output ports 4001-4064, in view to the destination output port of each data packet.

The bits of fixed sized cells that are destined to output port of the second to eighth portions 2.2-2.8 of network element 2 are provided in parallel to parallel output queues within these portions respectively.

Referring to FIG. 3a and FIG. 4a there is illustrated second portion 2.2 and eighth portion 2.8 of network element 2, according to a preferred embodiment of the invention. Second and eighth portions 2.2 and 2.8 are analogues to first portion 2.1 but differ from first portion 2.1 as they are adapted to receive and transmit a single WDM signal while first portion 2.1 is configured to receive and transmit sixty four single wavelength signals. Accordingly, each of second and eighth portions 2.2 and 2.8 has (i) a single multi-port input port 600 and 3600 accordingly instead of sixty four input ports 101-164 of first portion 2.1, (ii) a single output port 777 and 3777 instead of output ports 4001-4064, and (iii) a single output multiplexer 770 and 3770 and a plurality of optical transmitters for generating a WDM signal to be outputted from the single output port instead of having output crossbar 175 for directing data packets to a plurality of output ports.

According to another aspect of the invention, data packets arriving to an ingress network element are partitioned to fixed sized cells, each fixed sized cell is represented by a WDM signal, the WDM signal is switched along an optical path that starts at the ingress network elements and ends at a egress network element, at the egress network element the WDM signal is converted to a plurality of signals representative of the bits of a fixed sized cell, that are used to reconstruct the data packet. Generally speaking, the network elements illustrated at FIGS. 2, 3, 4, and 5 are “split” such that units and circuits the precede the optical switch can be found in ingress network elements, whereas the units and logics the follow the optical switch and the optical switch itself form the egress network elements. Accordingly, FIGS. 2b, 3b, 4b, 5b and 5c illustrate various portions of such network elements. The upper part of FIGS. 2b, 3b and 4b illustrate first portions of ingress network elements and are analogues to the upper part of FIGS. 2, 3, and 4 accordingly. The lower part of FIGS. 2b, 3b and 4b illustrate first portions of egress network elements and are analogues to the lower part of FIGS. 2, 3, and 4 accordingly. FIG. 5b illustrates an ingress network element switching module, while FIG. 5C illustrates the optical switch module of an egress network element. The former ends at the optical switch while the latter starts at the optical switch.

Referring to FIG. 8 illustrating input port 101. Input port 101 includes an optical to electrical (O/E) converter 101a, de-serializer 101b, de-framer 101c, memory unit 101m, network processor 101d and framer 101e. O/E converter 101a is configured to receive a frame, such as a 10 Gbs SONET frame and to convert it to an input electrical signal and provide the input electrical signal to deserializer 101b that performs a serial to parallel conversion of the input electrical signal to provide a plurality of lower bit rate signals. The lower bit rate signals can be handled by logic circuits within de-framer 101c and especially within network processor 101d. De-framer 101c strips the SONET header and provides the SONET payload to memory unit 101m, the memory unit 101m being accessible to network processor 101d and is managed by network processor 101d. Network processor 101d either receives an indication that the SONET payload was stored at memory unit 101m or otherwise scans the content of memory unit 101m and retrieves a portion of the SONET payload to be processed to determine to which output port to provide each data packet of the SONET payload. Usually, a SONET payload includes a plurality of data packets, each data packet has a header and a data payload. Each data packet is handled separately by network processor 101d. Network processor 101d analyses the data packet header to determine a selected local path across network element 10. Network processor 101d manages a plurality of queues within memory unit 101m. A queue can be maintained for each serial input queue, but additional queues can be maintained to guarantee quality of service demands, to support priorities, to enhance the fairness of handling data packet flows, for eliminating HOL blocking, and for allowing and enhancing multicast and broadcast capabilities.

According to one aspect of the invention, data packets entering network 1 are processed to determine the data packet destination. Control information that indicated that destination is encapsulated in a label attached to the data packet. When a data packet can be sent across input crossbar 170 to a serial input queue from serial input queues 201-264, the data packet is provided to framer 101e, that attaches a label to the data packet. Each serial input queue is configured to store at least one data packet or a burst of data packets that are destined to be sent to the same group of output ports. The label reflects a selected output port of network element 2. According to another preferred embodiment of the invention, a label is not added to the data packet and the destination is determined by processing at least a portion of the data packet itself. For example, assuming that the data packet has an IP header, then an IP forwarding process is performed at each network element that receives the data packet.

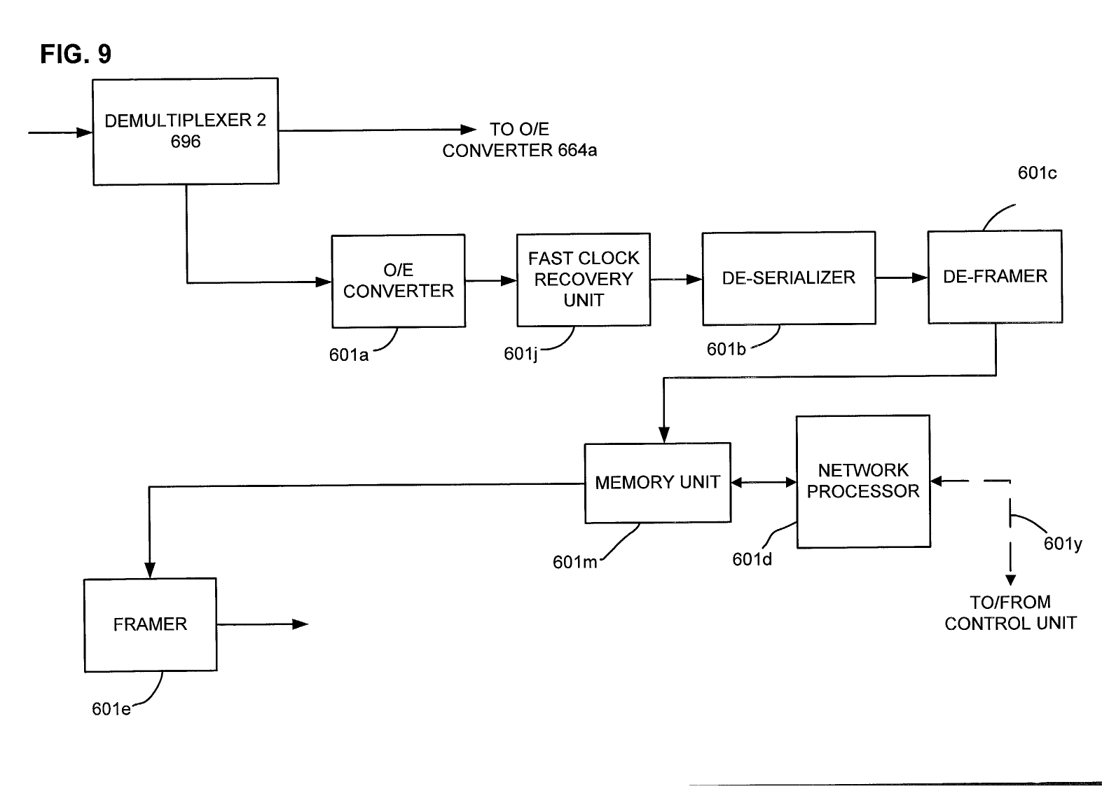

Referring to FIG. 9 there is illustrated a portion of input port 600. This portion includes demultiplexer 696 and a first channel 601 out of sixty four channels of input port 600. First channel 601 is analogues to input port 101 but has a fast clock recovery unit 601j, for performing clock recovery of data packets having a first wavelengths out of sixty four predefined wavelengths received by input port 600.

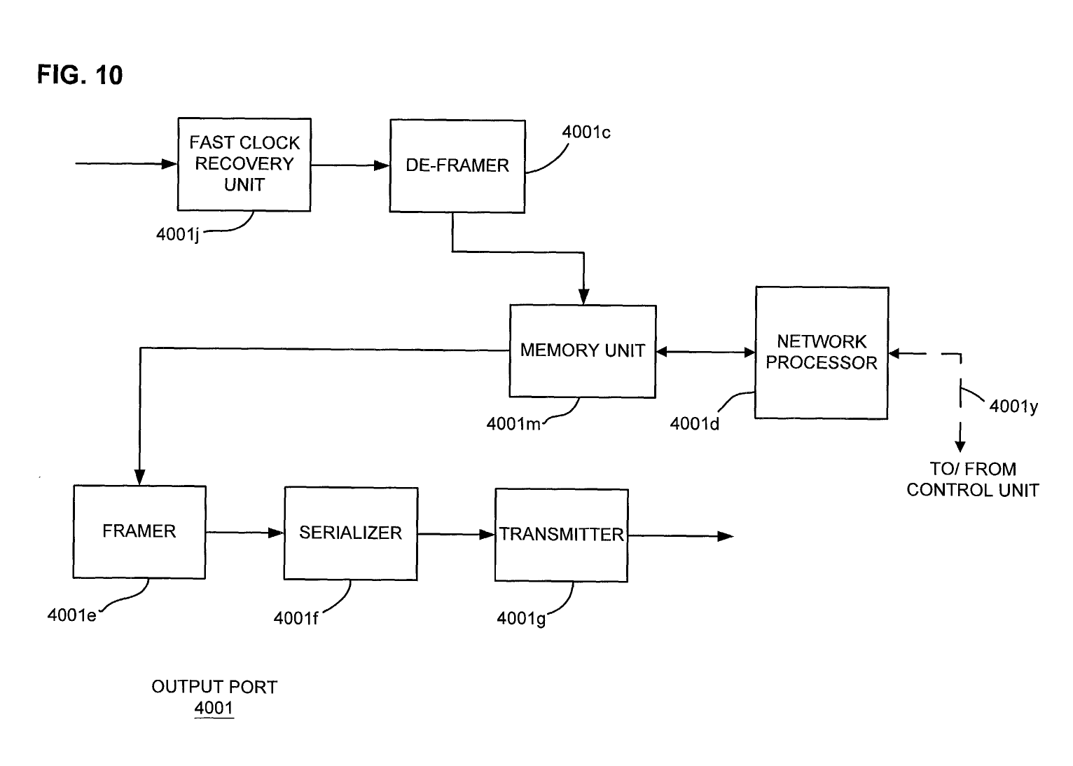

Referring to FIG. 10 there is illustrated output port 4001. Output port 4001 includes fast clock recovery unit 4001j, de-framer 4001c, memory unit 4001m, network processor 4001d, framer 4001e, serializer 4001f and transmitter 4001g.

Fast clock recovery unit 4001j receives electrical signals from optical switch module 5555 and performs reshaping and re-timing of the electrical signal and provides the reshaped and retimed signal to de-framer 4001c for stripping the label and for providing memory unit 4001m data packets. The data packets are either sent directly to framer 4001e or queued to provide a burst of data packets. Framer 4001e adds a SONET header to the data packets to generate low bit rate SONET frames. The low bit rate SONET frames are converted to a 10 Gbs SONET frames by serializer 4001f to be sent by transmitter 4001g to a destination located out of the network. Network processor control the transmission of the data packet and is further configured to implement various predefined management and processing schemes such as traffic engineering, output queue management.

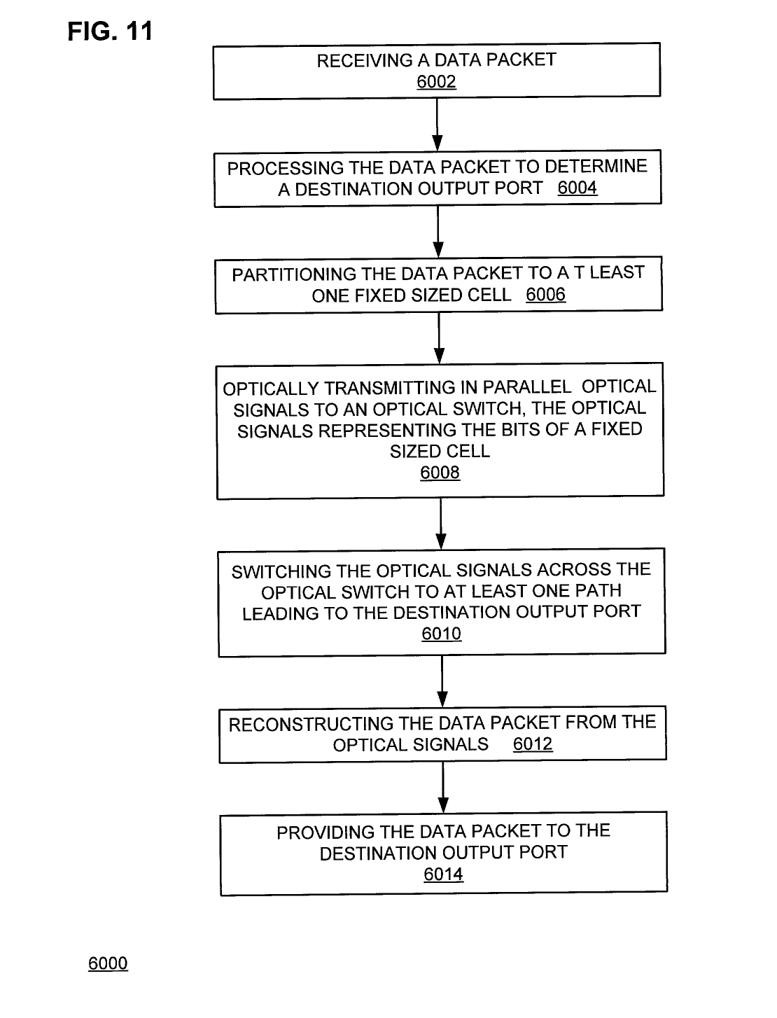

Referring to FIG. 11 there is illustrated method 6000 for propagating a data packet from an input port of a network element to an output port of the network element, the network element including a plurality of input ports and a plurality of output ports interconnected by an optical switch, according to a preferred embodiment of the invention.

Method 6000 starts at step 6002 of receiving the data packet at an input port of the network element. Referring to the example set forth in the previous figures, network element 2 receives data packet P1 at an input port 101.

Step 6002 is followed by step 6004 of processing the data packet to determine a destination output port out of the output ports of the network element. Referring to the example set forth in the previous figures, packet P1 is processed to determine that the destination output port is output port 4001.

Step 6004 is followed by step 6006 of partitioning the data packet to a plurality of fixed sized cells. Referring to the example set forth in the previous figures, spreading unit 180 fetches cells P(1,1)-P(1,5) and provides the bits of each fixed sized cell to bit arrangements units 301-364 during five nonconsecutive cycles.

Step 6006 is followed by step 6008 of optically transmitting in parallel optical signals to an optical switch, the optical signals being representative of all the bits of a fixed sized cell. Referring to the example set forth in the previous figures, bit arrangement units 301-364 provide P(1,1,1)-P(1,1,64) to sixty four E/O converters 5101 that generate and transmit sixty four optical signals, each having a distinct wavelength and each representative of a bit out of the sixty four bits of P(1,1). The sixty four optical signals are multiplexed to a single WDM signal by multiplexer 5111 that provides the WDM signal to optical switch 5100. The generation of the optical signals, the transmission of the optical signals and the configuration of optical switch 5100 are controlled by a central control unit (not shown). The central control unit receives requests to optically transmit optical signals from at least some of the eight portions 2.1-2.8 of network element 2 and selects which request to accept.

Step 6008 is followed by step 6010 of switching the optical signals across the optical switch to at least one path leading to the destination output port. Referring to the example set forth in the previous figures, optical switch 5100 receives the WDM signal representative of P(1,1) at input MWSI1 and switches it to output MWSO1, according to a previously received control signal.

Step 6010 is followed by steps 6021 and 6014 of reconstructing the data packet from the received optical signals and providing the data packet to the destination output port. Referring to the examples set forth at the previous figures, the WDM signal is received by de-multiplexer 5121 that converts it to up to sixty four optical signals, each having a distinct wavelength and each representing a single bit of P(1,1). The optical signals are converted by O/E converters 5102 to electrical signals representing bits P(1,1,1)-P(1,1,64). P(1,1,1)-P(1,1,64) are provided to parallel output queues 401-464 respectively. According to an aspect of the invention, steps 6008-6010 are repeated until fixed sized cells P(1,2)-P(1,5) are received at parallel output queues 401-464. Accumulator 190 accumulates the bits of P(1,1)-P(1,5) to provide serial output queue 501, associated with output port 4001, a serially stored data packet P1. P1 is sent to output port 4001 via output crossbar 175.

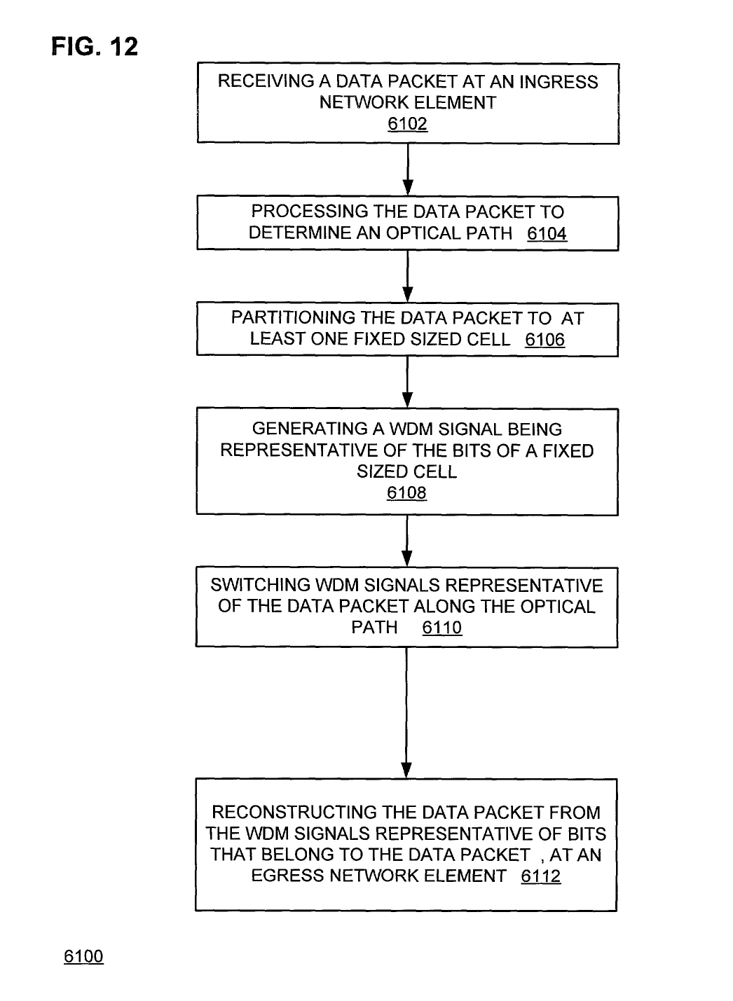

Referring to FIG. 12 there is illustrated method 6100 for propagating a data packet along an optical path that starts at an ingress network element and ends at an egress network element, according to a preferred embodiment of the invention.

Method 6100 starts at step 6102 of receiving the data packet at an ingress network element. Referring to the example set forth in the previous figures, an ingress network element receives data packet P1 at an input port 101.

Step 6102 is followed by step 6104 of processing the data packet to determine the optical path. The determination is first made at first portion 2.1.1 of egress network element.

Step 6104 is followed by step 6106 of partitioning the data packet to at least one fixed sized cell. Referring to the example set forth in the previous figures, spreading unit 180 fetches cells P(1,1)-P(1,5) and provides the bits of each fixed sized cell to bit arrangements units 301-364 during five nonconsecutive cycles.

Step 6106 is followed be step 6108 of generating a WDM optical signal being representative of all the bits of a fixed sized cell, for each fixed sized cell of the data packet. Referring to the example set forth at the previous figures, electrical signals, each representing of a single bit are provided to E/O converters 5101 within ingress optical switch module 5555′ of FIG. 5ab.

Step 6108 is followed by step 6110 of switching WDM signal representative of the data packet across the optical path. Conveniently, the WDM signal is switched through a plurality of intermediate network elements that are configured to receive and switch WDM signals. According to one aspect of the invention, destination information representative of the optical path has predefined wavelengths, for allowing the conversion and the analysis of the destination information without converting or otherwise causing a degradation of the WDM signal payload. According to yet a further embodiment of the invention, the intermediate network elements are analogues to network elements such as network elements 2, 48 and 90 of FIG. 1 but do not have input crossbar such as input crossbar 170, serial input queues such as serial input queues 201-264, and spreading unit 180, as the WDM signals arriving to the intermediate network elements are already can be received by bit arrangement units such as 301-364. Furthermore, intermediate network elements do not have accumulator 3690 and signals received at parallel output queues such as parallel output queues 3901-3964 can be directly coupled via E/O converters 5101 to output multiplexers such as output multiplexer 3770.

Step 6110 is followed by step 6112 of reconstructing the data packet from the WDM signals representative of fixed sized cells belonging to the data packet, at an egress network element along the optical path. Referring to the example set forth at the previous figures, egress network element has a first portion 2.1.2 in which a plurality of parallel transmitted bits of a fixed sized cell are stored at parallel output queues 401-464, and the bits belonging to the same data packet are accumulated by accumulator 190 to provide serially stored data packets within serial output queues such as output serial queues 501-564, to be provided to the appropriate output port via output crossbar 175.

It will be apparent to those skilled in the art that the disclosed subject matter may be modified in numerous ways and may assume many embodiments other then the preferred form specifically set out and described above.

Accordingly, the above disclosed subject matter is to be considered illustrative and not restrictive, and to the maximum extent allowed by law, it is intended by the appended claims to cover all such modifications and other embodiments, which fall within the true spirit and scope of the present invention.

The scope of the invention is to be determined by the broadest permissible interpretation of the following claims and their equivalents rather then the foregoing detailed description.

We claim:

1. A method for propagating a data packet from an input port of a network element to an output port of the network element, the network element comprising a plurality of input ports and a plurality of output ports interconnected by an optical switch, the method comprising the steps of:
(a) receiving the data packet at an input port;
(b) processing the data packet to determine a destination output port out of the output ports of the network element;
(c) partitioning the data packet to at least one fixed sized cell;
(d) optically transmitting in parallel optical signals to an optical switch, the optical signals being representative of all the bits of a fixed sized cell, for each fixed sized cell of the data packet;
(e) switching the optical signals across the optical switch in view of the destination output port;
(f) reconstructing the data packet from the received optical signals,
(g) providing the data packet to the destination output port.

2. The method of claim 1 wherein at least one step selected from the group consisting of step (d) and step (e) is repeated during consecutive switching cycles of the optical switch.

3. The method of claim 1 wherein each optical signal represents a bit of the fixed sized cell and wherein each optical signal has a single distinct wavelength.

4. The method of claim 1 wherein step (d) is followed by a step of multiplexing the optical signals to provide a wavelength division multiplexed (WDM) signal;
wherein step (e) involves switching the WDM signal; and
wherein step (e) is followed by a step of converting the WDM signal to a plurality of electrical signals.

5. The method of claim 4 wherein each electrical signal being representative of a single bit of the fixed sized cell.

6. The method of claim 1 wherein the number of bits within a fixed sized cell substantially equals 2.sub.x, x being a positive integer.

7. The method of claim 1 wherein the network element is configured to handle WDM signals of up to J multiplexed optical signals and wherein the number of bits within a fixed sized cell corresponds to J.

8. The method of claim 1 further comprising a step of accumulating data packets to provide a data packet burst.

9. The method of claim 8 wherein steps (d) and (e) are repeated until all bits of the data packet burst are switched.

10. The method of claim 9 wherein a data packet burst comprising data packets destined to the same group of output ports.

11. The method of claim 9 wherein step (f) comprises converting the optical signals being received in parallel to a plurality of serially stored electrical signals, wherein the plurality of electrical signal being representative of a fixed sized cell.

12. The method of claim 11 wherein step (f) further comprises accumulating electrical signals being representative of fixed sized cells of the same data packet to provide a serially stored data packet.

13. The method of claim 1 wherein a data packet comprises control information for allowing to determine the destination output port.

14. The method of claim 13 wherein the network element is configured to read the control information without reading other parts of the data packets.

15. The method of claim 13 wherein each optical signal represents a bit of the fixed sized cell and wherein bits of the control information have predefined wavelengths.

16. A method for propagating a data packet from an input port of a network element to an output port of the network element, the network element comprising a plurality of input ports and a plurality of output ports interconnected by an optical switch, the method comprising the steps of:
(a) receiving the data packet at an input port;
(b) processing the data packet to determine a destination output port out of the output ports of the network element;
(c) partitioning the data packet to a plurality of fixed sized cells;
(d) optically transmitting in parallel optical signals to an optical switch, the optical signals being representative of all the bits of a fixed sized cell;
(e) switching the optical signals across the optical switch in view of the destination output port, during a single switching cycle; wherein jumping to step (d) until all the fixed sized cell of the data packet are transmitted and switched;
(f) converting the optical signals to electrical signals being representative of the fixed size cells of the data packet;
(g) accumulating electrical signals being representative of fixed sized cells of the same data packet to provide a data packet; and
(h) providing the data packet to the destination output port.

17. The method of claim 16 wherein at least one step selected from the group consisting of step (d) and step (e) is repeated during consecutive switching cycles of the optical switch.

18. The method of claim 16 wherein each optical signal represents a bit of the fixed sized cell and wherein each optical signal has a single distinct wavelength.

19. The method of claim 16 wherein step (d) is followed by a step of multiplexing the optical signals to provide a wavelength division multiplexed (WDM) signal;
wherein step (e) involves switching the WDM signal; and
wherein step (e) is followed by a step of converting the WDM signal to a plurality of electrical signals.

20. The method of claim 19 wherein each electrical signal being representative of a single bit of the fixed sized cell.

21. The method of claim 16 wherein the number of bits within a fixed sized cell substantially equals 2.sub.x, x being a positive integer.

22. The method of claim 16 wherein the network element is configured to handle WDM signals of up to J multiplexed optical signals and wherein the number of bits within a fixed sized cell corresponds to J.

23. The method of claim 16 further comprising a step of accumulating data packets to provide a data packet burst.

24. The method of claim 23 wherein steps (d) and (e) are repeated until all bits of the data packet burst are switched.

25. The method of claim 24 wherein data packet bursts comprising data packets destined to the same destination group of output ports.

26. The method of claim 24 wherein step (f) comprises converting the optical signals being received in parallel to a plurality of serially stored electrical signals, wherein the plurality of electrical signal being representative of a fixed sized cell.

27. The method of claim 26 wherein step (f) further comprises accumulating electrical signals being representative of fixed sized cells of the same data packet to provide a serially stored data packet.

28. The method of claim 16 wherein a data packet comprises control information for allowing to determine the destination output port.

29. The method of claim 28 wherein the network element is configured to read the control information without reading other parts of the data packets.

30. The method of claim 28 wherein each optical signal represents a bit of the fixed sized cell and wherein bits of the control information have predefined wavelengths.

31. The method of step 28 wherein the network element is interconnected to at least one network elements to form a network and wherein step (b) is followed by a step of adding a label being representative of at least a portion of the control information, if the network element acts as an ingress element.

32. The method of claim 31 further comprising as step of removing the label, if the network element acts as an egress element.

33. A method for propagating a data packet from an input port of a network element to an output port of the network element, the network element comprising a plurality of input ports and a plurality of output ports interconnected by an optical switch, the method comprising the steps of:
(a) receiving the data packet at an input port;
(b) processing the data packet to determine a destination output port out of the output ports of the network element;
(c) partitioning the data packet to a plurality of fixed sized cells;
(d) configuring the optical switch to switch in parallel the bits of a fixed sized cell to a destination path leading to the destination output port, for each fixed sized cell of the data packet;
(e) optically transmitting the bits of a fixed sized cell to the optical switch, for each fixed sized cell of the data packet;
(f) switching in parallel the transmitted bits to the destination path, for each fixed sized cell of the data packet;
(g) reconstructing the data packet from the transmitted bits; and
(h) providing the data packet to the destination output port.

34. The method of claim 33 wherein step (e) is preceded by the steps of:
storing the data packet in an input serial queue out of a plurality of input serial queues, in view of a predefined criterion associated with the content of at least a portion of the data packet; and
spreading the bits of fixed sized cells of data packets being located at a top of an input serial queue among a plurality of input parallel queues, for allowing to provide all bits of a fixed sized cell to the optical switch in parallel.

35. The method of claim 34 wherein step (h) comprising storing the bits of a fixed sized cell being received in parallel from the optical switch at a plurality of output parallel queues, such that all the bits of the fixed sized cell are aligned; and accumulating bits of the fixed sized cell being stored at the top of output parallel queues to provide the fixed sized cell, for each fixed sized cell of a data packet.

36. The method of claim 35 wherein the bits of a fixed sized cell are accumulated at a serial output queue associated with the destination output port of the data packet.

37. The method of claim 33 wherein at least one step selected from the group consisting of steps (e) and (f) is repeated during consecutive switching cycles of the optical switch.

38. The method of claim 33 wherein each optical signal represents a bit of the fixed sized cell and wherein each optical signal has a single distinct wavelength.

39. The method of claim 33 wherein step (d) is followed by a step of multiplexing the optical signals to provide a wavelength division multiplexed (WDM) signal, step (f) comprising switching the WDM signal; and
wherein step (f) is followed by a step of converting the WDM signal to a plurality of electrical signals.

40. The method of claim 39 wherein each electrical signal being representative of a single bit of the fixed sized cell.

41. The method of claim 33 wherein the number of bits within a fixed sized cell substantially equals 2.sub.x, x being a positive integer.

42. The method of claim 33 wherein the network element is configured to handle WDM signals of up to J multiplexed optical signals and wherein the number of bits within a fixed sized cell corresponds to J.

43. The method of claim 33 further comprising a step of accumulating data packets to provide a data packet burst.

44. The method of claim 43 wherein steps (e) and (f) are repeated until all bits of the data packet burst are switched to the destination output port.

45. The method of claim 44 wherein a data packet burst comprising data packets destined to the same group of output ports.

46. The method of claim 44 wherein step (h) comprising converting the optical signals being received in parallel to a plurality of serially stored electrical signals, wherein the plurality of electrical signal being representative of a fixed sized cell.

47. The method of claim 46 wherein step (h) further comprising accumulating electrical signals being representative of fixed sized cells of the same data packet to provide a serially stored data packet.

48. The method of claim 33 wherein a data packet comprises control information for allowing to determine the destination output port.

49. The method of claim 48 wherein the network element is configured to read the control information without reading other parts of the data packets.

50. The method of claim 48 wherein each optical signal represents a bit of the fixed sized cell and wherein bits of the control information have predefined wavelengths.

51. A network element comprising:
a plurality of input ports, each input port is configured to receive data packets and process at least a portion of each data packet to determine the destination output port associated with the data packet;
a plurality of serial to parallel converters, coupled to the plurality of input ports and to an optical switch, each serial to parallel converter is configured to receive a data packet, to segment the data packet to at least one fixed sized cell and to provide the bits of each fixed size cell in parallel to the optical switch;
an optical switch module for switching all bits of a fixed size cell in parallel to parallel to serial converters; and
a plurality of parallel to serial converters, coupled to the optical switch module and to a plurality of output ports of the network element, the parallel to serial converters are configured to receive the bits of fixed sized cells in parallel and to provide data packets to the plurality of output ports.

52. The network element of claim 51 wherein the optical switch module is configured to switch consecutive fixed size cells belonging to the same data packet during consecutive switching cycles.

53. The network element of claim 51 wherein the serial to parallel converters provide electrical signals to the optical switch module; and wherein the optical switch module comprising:
a plurality of electrical to optical converters, for converting the electrical signals to optical signals, each optical signal being representative of a bit of the fixed sized cell;
an plurality of multiplexers, coupled to a plurality of electrical to optical converters, each multiplexer for multiplexing optical signals being representative of the bits of a fixed sized cell to a WDM signal;
at least one optical switch, coupled to the plurality of multiplexers and to a plurality of de-multiplexers, for switching the WDN signal in view of the destination output port;
a plurality of de-multiplexers, coupled to one of the at least one optical switch, for receiving the WDM signal and splitting the WDM signal to a plurality of optical signals; and
a plurality of optical to electrical converters, for converting the plurality of optical signals to a plurality of electrical signals, each electrical signal being representative of a bit of the fixed sized cell.

54. The network element of claim 53 wherein each optical signal being representative of a single bit of the fixed sized cell.

55. The network element of claim 51 wherein the number of bits within a fixed sized cell substantially equals 2.sub.x, x being a positive integer.

56. The network element of claim 51 wherein the network element is configured to handle WDM signals of up to J multiplexed optical signals and wherein the number of bits within a fixed sized cell corresponds to J.

57. The network element of claim 51 further comprising at least one burst generator for accumulating data packets to provide a data packet burst.

58. The network element of claim 57 wherein all the bits of a data packet burst are switched continuously.

59. The network element of claim 57 wherein the burst generator comprising an input crossbar coupled to a plurality of input serial queues.

60. The network element of claim 59 wherein data packets provided to the input crossbar are sent to an input serial queue out of the plurality of input serial queues, in view of a predefined criterion associated with the content of at least a portion of the data packets.

61. The network element of claim 51 wherein the serial to parallel converters comprising:
a plurality of input parallel queues, wherein each input parallel queue is coupled to a single input port of the optical switch module, for providing a single bit to the optical switch module; and
a spreading unit, coupled to the plurality of output parallel queues and to the plurality of input serial queues, for spreading the bits of fixed sized cells of data packets being located at a top of input serial queues among the plurality of input parallel queues.

62. The network element of claim 51 further comprising:
a plurality of output parallel queues, coupled to the optical switch module, for storing the bits of a fixed sized cell being received in parallel from the optical switch module; and
an accumulator, coupled to the plurality of output parallel queues and to the plurality of output ports, for accumulating bits of fixed sized cell being stored at the top of output parallel queues to provide a serially stored fixed size cell.

63. A method for propagating a data packet across network elements along an optical path, each network element along the optical path comprising a plurality of input ports and a plurality of output ports interconnected by an optical switch, the method comprising the steps of:
(a) receiving the data packet at an ingress network element along the optical path;
(b) processing the data packet to determine the optical path;
(c) partitioning the data packet to at least one fixed sized cell;
(d) generating a WDM optical signal being representative of all the bits of a fixed sized cell, for each fixed sized cell of the data packet;
(e) switching WDM signals representative of the data packet across the optical path; and
(f) reconstructing the data packet from the WDM signals representative of fixed sized cells belonging to the data packet, at an egress network element along the optical path.

64. The method of claim 63 wherein step (d) and (e) are repeated during consecutive switching cycles of the optical switch.

65. The method of claim 63 wherein each WDM signal comprising a plurality of optical signals, each optical signal represents a bit of the fixed sized cell and wherein each optical signal has a single distinct wavelength.

66. The method of claim 63 wherein step (f) comprising the step of converting the WDM signal to a plurality of electrical signals.

67. The method of claim 66 wherein each electrical signal being representative of a single bit of the fixed sized cell.

68. The method of claim 63 wherein the number of bits within a fixed sized cell substantially equals 2.sub.x, x being a positive integer.

69. The method of claim 63 wherein the network element is configured to handle WDM signals of up to J multiplexed optical signals and wherein the number of bits within a fixed sized cell corresponds to J.

70. The method of claim 63 further comprising a step of accumulating data packets to provide a data packet burst.

71. The method of claim 70 wherein steps (d) and (e) are repeated until all bits of the data packet burst are switched.

72. The method of claim 71 wherein a data packet burst comprising data packets destined to the same group of output ports.

73. The method of claim 71 wherein step (f) comprises converting the optical signals being received in parallel to a plurality of serially stored electrical signals, wherein the plurality of electrical signal being representative of a fixed sized cell.

74. The method of claim 73 wherein step (f) further comprises accumulating electrical signals being representative of fixed sized cells of the same data packet to provide a serially stored data packet.

75. The method of claim 63 wherein a data packet comprises control information for allowing to determine the optical path.

76. The method of claim 75 wherein the network element is configured to read the control information without reading other parts of the data packets.

77. The method of claim 75 wherein each optical signal represents a bit of the fixed sized cell and wherein bits of the control information have predefined wavelengths.

78. The method of claim 63 wherein step (e) is preceded by a step of configuring the optical switch to switch the WDM signals along the optical path.

79. The method of claim 63 wherein step (e) is preceded by the steps of:
storing the data packet in an input serial queue out of a plurality of input serial queues, in view of a predefined criterion associated with the content of at least a portion of the data packet; and
spreading the bits of fixed sized cells of data packets being located at a top of an input serial queue among a plurality of input parallel queues, for allowing to provide a WDM signal representative of all bits of a fixed sized cell.

80. The method of claim 63 wherein step (f) comprising storing the bits of a fixed sized cell being received in parallel from the optical switch at a plurality of output parallel queues, such that all the bits of the fixed sized cell are aligned; and accumulating bits of the fixed sized cell being stored at the top of output parallel queues to provide the fixed sized cell, for each fixed sized cell of a data packet.

81. The method of claim 80 wherein the bits of a fixed sized cell are accumulated at a serial output queue associated with the destination output port of the data packet.

82. The method of claim 63 wherein steps (e) and (f) are repeated during consecutive switching cycles of the optical switch.

83. A network comprising a plurality of network elements interconnected by optical links, at least one network element being an ingress network element, at least one network element being an egress network element, at least one network element being an intermediate network element, the network is configured to accommodate a plurality of optical paths between ingress and egress network elements;
an ingress network element comprising:
a plurality of input ports, each input port is configured to receive data packets and process at least a portion of each data packet to determine the destination output port associated with the data packet;
a plurality of serial to parallel converters, coupled to the plurality of input ports and to an optical switch, each serial to parallel converter is configured to receive a data packet, to segment the data packet to at least one fixed sized cell and to generate WDM signals, each WDM signal representative of a fixed size cell; and
at least one optical switch module for switching WDM signals in view of the optical path of the data packet.

84. The network of claim 83 wherein an egress network element comprising a plurality of parallel to serial converters, adapted to receive the WDM signals, and to reconstruct a data packet from WDM signals representative of fixed sized cells belonging to the data packet.

85. The network of claim 84 wherein intermediate network elements are configured to switch WDM signals across the optical path.

86. The network of claim 83 wherein the optical switch module is configured to switch consecutive fixed size cells belonging to the same data packet during consecutive switching cycles.

87. The network of claim 83 wherein the serial to parallel converters provide electrical signals to the optical switch module; and wherein the optical switch module comprising:
a plurality of electrical to optical converters, for converting the electrical signals to optical signals, each optical signal being representative of a bit of the fixed sized cell;
an plurality of multiplexers, coupled to a plurality of electrical to optical converters, each multiplexer for multiplexing optical signals being representative of the bits of a fixed sized cell to a WDM signal;
an optical switch, coupled to the plurality of multiplexers and to a plurality of de-multiplexers, for switching the WDN signal in view of the optical path.

88. The network of claim 84 wherein an egress network element further comprising a plurality of de-multiplexers, for receiving the WDM signal and splitting the WDM signal to a plurality of optical signals; and
a plurality of optical to electrical converters, for converting the plurality of optical signals to a plurality of electrical signals, each electrical signal being representative of a bit of the fixed sized cell.

88. The network of claim 84 wherein each optical signal being representative of a single bit of the fixed sized cell.

89. The network of claim 88 wherein the number of bits within a fixed sized cell substantially equals 2.sub.x, x being a positive integer.

90. The network of claim 83 wherein network elements are configured to handle WDM signals of up to J multiplexed optical signals and wherein the number of bits within a fixed sized cell corresponds to J.

91. The network of claim 83 wherein an ingress network element further comprising at least one burst generator for accumulating data packets to provide a data packet burst.

92. The network of claim 91 wherein all the bits of a data packet burst are switched continuously.

93. The network of claim 91 wherein the burst generator comprising an input crossbar coupled to a plurality of input serial queues.

94. The network of claim 91 wherein data packets provided to the input crossbar are sent to an input serial queue out of the plurality of input serial queues, in view of a predefined criterion associated with the content of at least a portion of the data packets.

95. The network of claim 83 wherein the serial to parallel converters comprising:
a plurality of input parallel queues, wherein each input parallel queue is coupled to a single input port of the optical switch module, for providing a single bit to the optical switch module; and
a spreading unit, coupled to the plurality of output parallel queues and to the plurality of input serial queues, for spreading the bits of fixed sized cells of data packets being located at a top of input serial queues among the plurality of input parallel queues.

96. The network of claim 84 wherein an egress network element further comprising:
a plurality of output parallel queues, for storing the bits of a fixed sized cell being received in parallel from the optical switch module; and
an accumulator, coupled to the plurality of output parallel queues and to the plurality of output ports, for accumulating bits of fixed sized cell being stored at the top of output parallel queues to provide a serially stored fixed size cell.
